(19) United States
(12) Patent Application Publication
(10) Pub. No.: US 2015/0052430 A1
(43) Pub. Date: Feb. 19, 2015

(54) GESTURES FOR SELECTING A SUBSET OF CONTENT ITEMS

(71) Applicant: Dropbox, Inc., San Francisco, CA (US)

(72) Inventor: Michael DWAN, San Francisco, CA (US)

(73) Assignee: Dropbox, Inc., San Francisco, CA (US)

(21) Appl. No.: 13/965,734

(22) Filed: Aug. 13, 2013

(51) Int. Cl. G06F 3/01; G06F 3/0488

(52) U.S. Cl. CPC G06F 3/016; G06F 3/0488
USPC 715/702

(57) ABSTRACT

Systems, methods, and non-transitory computer readable mediums for selecting a subset of content items from a plurality of content items on a user device using various gestures are provided. Such methods may include displaying a plurality of content items on a touch-sensing display interface of a user device, detecting a first tactile gesture on the touch-sensing display interface, the first tactile gesture engaging a selection mode, detecting a second tactile gesture on the touch-sensing display interface, the second touch gesture selecting and placing at least one of the plurality of content items in a subset of content items, and in response to the detected gestures, performing an action with the subset of content items.

### FIELD OF THE INVENTION

Various embodiments generally relate to gestures for selecting a subset or subsets of content items.

### BACKGROUND

With the increased use of mobile devices in modern society, various types of content items, such as photographs and/or music, are now readily accessible to individuals anywhere and at any time on various user devices. As technology continues to improve, and thus the greater efficiency and lower cost of memory, more and more content items are capable of being stored on mobile devices. However, with this increased amount of storage, selecting subsets of content items (e.g., for sharing) from the totality of content items stored on a user's mobile device has become increasingly difficult. In many situations, in order to create a subset of content items, a user may have to individually select each content item from a larger list of content items. This may be a difficult and cumbersome task when the subset contains multiple items, the list of content items is extremely large, and/or if the subset is being created by an individual who may not have steady or consistent control of their mobile device. For example, individuals with nervous system illnesses (e.g., Parkinson's disease), arthritic conditions, reduced dexterity and muscle control, or the like, may have difficulty maintaining balance of their mobile device, or in entering precise control signals. Therefore, it would be beneficial to provide a simple, convenient, and elegant mechanism that would allow a subset or subsets of content items to be selected from a larger set of content items.

### SUMMARY

Systems, methods, and non-transitory computer readable mediums for selecting a subset of content items from a plurality of content items on a user device using various gestures are provided. Such systems may include one or more processors, a touch-sensing display interface, and memory containing instructions.

Exemplary methods according to the present invention may include displaying a plurality of content items on a touch-sensing display interface. The touch-sensing display interface may correspond to a touch screen on a mobile device such as, for example, a smart phone, a tablet, a personal digital assistant (“PDA”), a digital wrist watch, or any other type of mobile device. It should be noted that the term “touch-sensing display interface” is used herein to refer broadly to a wide variety of touch displays and touch screens. A first touch gesture may be detected with the touch-sensing display interface to engage a selection mode. For example, holding down an object or finger on a touch-sensing display interface for a predefined period of time, sometimes referred to as a “long press,” may engage the selection mode. While in the selection mode, a second touch gesture may also be detected by the touch-sensing display interface to select one or more of the displayed content items and place them in a subset of content items. For example, a swiping motion may be performed on a touch screen displaying the plurality of content items to select the subset of content items. In some embodiments, a subsequent action may be performed on the identified subset of content items. For example, the subset of content items may be shared with one or more authorized accounts or users of a content management system, a contact, and/or one or more social media networks.

### BRIEF DESCRIPTION OF THE DRAWINGS

The above and other aspects and advantages of the invention will become more apparent upon consideration of the following detailed description, taken in conjunction with the accompanying diagrams, in which like references characters refer to like parts throughout, and in which:

FIG. 1 is an exemplary system for selecting a subset of content items using gestures in accordance with various embodiments;

FIG. 2A is a schematic illustration of a display in accordance with various embodiments;

FIG. 2B is a side view of a user providing a gesture to a touch-sensing display screen in accordance with various embodiments;

FIG. 2C is a graphical illustration of a gesture to engage in a selection mode in accordance with various embodiments;

FIGS. 3A and 3B are both schematic illustrations of a display in accordance with various embodiments;

FIGS. 4A and 4B are both schematic illustrations of a display in accordance with various embodiments;

FIGS. 5A and 5B are both schematic illustrations of a display in accordance with various embodiments;

FIG. 6 is a graphic illustration of gestures to engage in a selection mode and to select content items;

FIG. 7 is a schematic illustration of a side view of a user providing a gesture in accordance with various embodiments;

FIGS. 8A and 8B are both schematic illustrations of perspective views of a user providing a gesture in accordance with various embodiments; and

FIGS. 9-14 are illustrative flowcharts of various processes that use gestures to select content items in accordance with various embodiments.

### DETAILED DESCRIPTION OF THE DISCLOSURE

Methods, systems, and computer readable media for detecting gestures for selecting a subset of content items are provided. Content items may be displayed on a touch-sensing display interface. Various gestures may be detected with the touch-sensing display interface that may engage a selection mode and/or select and place content items in a subset of content items. Various actions may also be performed on the subset of content items once the subset has been created.

Content items may be any item that includes content accessible to a user of a mobile device. The use of “content item” or “content items” is used herein to refer broadly to various file types. In some embodiments, content items may include digital photographs, documents, music, videos, or any other type of file, or any combination thereof and should not be read to be limited to one specific type of content item. In some embodiments the content items may be stored in memory of a mobile device, on a content management system, on a social media network, or any other location, or any combination thereof.

Gestures may be any gesture or combination of gestures performed by a user of a mobile device. The use of “gesture” or “touch gesture” are used herein to refer broadly to a wide variety of movements, motions, inferences, or any other type or expression. In some embodiments, gestures may be performed by one or more fingers of a user of a mobile device, one or more fingers of an individual accessing the mobile device, and/or an object, such as a stylus, operable to interface with a touch screen on a mobile. The use of “object” or “objects” are used herein to refer broadly to any object capable of interfacing with a touch-sensing display interface. In some embodiments, gestures may include audio commands (e.g., spoken commands). In some embodiments, gestures may include a combination of gestures performed by one or more fingers or objects and audio commands. In some embodiments, gestures may include tracked motion using a motion tracking system or module.

For purposes of description and simplicity, methods, systems and computer readable media will be described for selecting a subset of content items using gestures. However, the terms “device” and “content management system” are used herein to refer broadly to a wide variety of storage providers and management service providers, electronic devices and mobile devices, as well as to a wide variety of types of content, files, portions of files, and/or other types of data. The term “user” is also used herein broadly and may correspond to a single user, multiple users, authorized accounts, or any other user type, or any combination thereof. Those with skill in the art will recognize that the methods, systems, and media described may be used for a variety of storage providers/services and types of content, files, portions of files, and/or other types of data.

The present invention may take form in various components and arrangements of components, and in various techniques, methods, or procedures and arrangements of steps. The referenced drawings are only for the purpose of illustrating embodiments, and are not to be construed as limiting the present invention. Various inventive features are described below that may each be used independently of one another or in combination with other features.

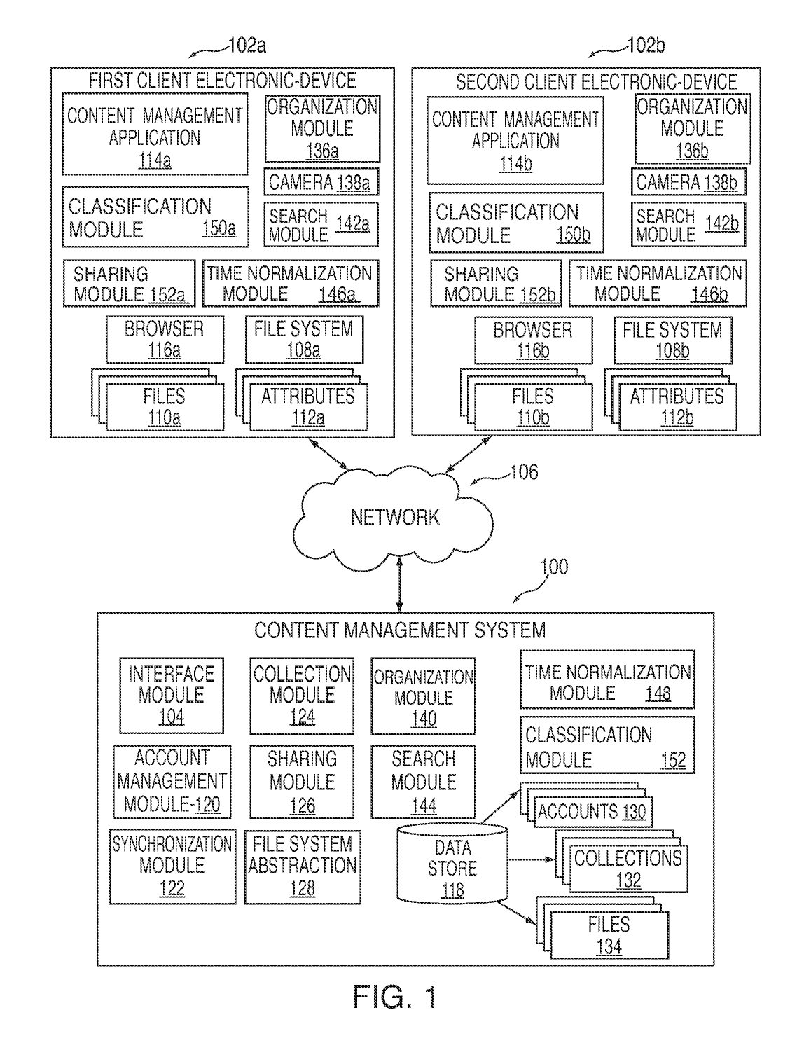

FIG. 1 is an exemplary system in which exemplary gesture driven interactions may be implemented in accordance with some embodiments of the invention. Elements in FIG. 1, including, but not limited to, first client electronic device 102a, second client electronic device 102b, and content management system 100, may communicate with each other and/or additional components inside or outside the system by sending and/or receiving data over network 106. Network 106 may be any network, combination of networks, or network devices that may carry data communication. For example, network 106 may be any one or any combination of a LAN (local area network), WAN (wide area network), telephone network, wireless network, point-to point network, star network, token ring network, hub network, or any other suitable network.

Network 106 may support any number of protocols, including but not limited to TCP/IP (Transfer Control Protocol and Internet Protocol), HTTP (Hypertext Transfer Protocol), WAP (wireless application protocol), etc. For example, first client electronic device 102a and second client electronic device 102b (collectively 102) may communicate with content management system 100 using TCP/IP, and, at a higher level, use browser 116 to communicate with a web server (not shown) at content management system 100 using HTTP. Exemplary implementations of browser 116, include, but are not limited to, Google Inc. Chrome™ browser, Microsoft Internet Explorer®, Apple Safari®, Mozilla Firefox, and Opera Software Opera.

A variety of client electronic devices 102 may communicate with content management system 100, including, but not limited to, desktop computers, mobile computers, mobile communication devices (e.g., mobile phones, smart phones, tablets), televisions, set-top boxes, and/or any other network enabled device. Although two client electronic devices 102a and 102b are illustrated for description purposes, those with skill in the art will recognize that any number of devices may be supported by and/or communicate with content management system 100. Client electronic devices 102 may be used to create, access, modify, and manage files 110a and 110b (collectively 110) (e.g. files, file segments, images, etc.) stored locally within file system 108a and 108b (collectively 108) on client electronic device 102 and/or stored remotely with content management system 100 (e.g., within data store 118). For example, client electronic device 102a may access file 110b stored remotely with data store 118 of content management system 100 and may or may not store file 110b locally within file system 108a on client electronic device 102a. Continuing with the example, client electronic device 102a may temporarily store file 110b within a cache (not shown) locally within client electronic device 102a, make revisions to file 110b, and communicate and store the revisions to file 110b in data store 118 of content management system 100. Optionally, a local copy of the file 110a may be stored on client electronic device 102a.

Client devices 102 may capture, record, and/or store content items, such as image files 110. For this purpose, client devices 102 may include a camera 138 (e.g., 138a and 138b) to capture and record digital images and/or videos. For example, camera 138 may capture and record images and store metadata with the images. Metadata may include, but is not limited to, the following: creation time timestamp, geolocation, orientation, rotation, title, and/or any other attributes or data relevant to the captured image.

Metadata values may be stored in attribute 112 as name-value pairs, tag-value pairs, and/or using any other suitable method to associate the metadata with the file and easily identify the type of metadata. In some embodiments, attributes 112 may be tag-value pairs defined by a particular standard, including, but not limited to, Exchangeable Image File Format (Exif), JPEG File Interchange Format (Jfif), and/or any other standard.

A time normalization module 146 (e.g., 146a and 146b) may be used to normalize dates and times stored with a content item. An example of time normalization is provided in U.S. patent application Ser. No. 13/888,118, entitled “Date and Time Handling,” filed on May 6, 2013, which is incorporated herein by reference in its entirety. Time normalization module 146, counterpart time normalization module 148, and/or any combination thereof may be used to normalize dates and times stored for content items. The normalized times and dates may be used to sort, group, perform comparisons, perform basic math, and/or cluster content items.

Organization module 136 (e.g., 136a and 136b) may be used to organize content items (e.g., image files) into clusters, organize content items to provide samplings of content items for display within user interfaces, and/or retrieve organized content items for presentation. Various examples of organizing content items are more fully described in commonly owned U.S. patent application Ser. No. 13/888,186, entitled “Presentation and Organization of Content,” filed on May 6, 2013, which is incorporated herein by reference in its entirety.

The organization module 136 may utilize any suitable clustering algorithm. The organization module 136 may be used to identify similar images for clusters in order to organize content items for presentation within user interfaces on devices 102 and content management system 100. Similarity rules may be defined to create one or more numeric representations embodying information on similarities between each of the content items in accordance with the similarity rules. The organization module 136 may use the numeric representation as a reference for similarity between content items in order to cluster the content items.

In some embodiments, content items may be organized into clusters to aid with retrieval of similar content items in response to search requests. For example, organization module 136a may identify that two stored images are similar and may group the images together in a cluster. Organization module 136a may process image files to determine clusters independently or in conjunction with counterpart organization module (e.g., 140 and/or 136b). In other embodiments, organization module 136a may only provide clusters identified with counterpart organization modules (e.g., 140 and/or 136b) for presentation. Continuing with the example, processing of image files to determine clusters may be an iterative process that is executed upon receipt of new content items and/or new similarity rules.

In some embodiments, a search module 142 on client device 102 may be provided with a counterpart search module 144 on content management system 144 to support search requests for content items. A search request may be received by search module 142 and/or 144 that requests a content item. In some embodiments, the search may be handled by searching metadata and/or attributes assigned to content items during the provision of management services. For example, cluster markers stored with images may be used to find images by date. In particular, cluster markers may indicate an approximate time or average time for the images stored with the cluster marker in some embodiments, and the marker may be used to speed the search and/or return the search results with the contents of the cluster with particular cluster markers.

Files 110 managed by content management system 100 may be stored locally within file system 108 of respective devices 102 and/or stored remotely within data store 118 of content management system 100 (e.g., files 134 in data store 118). Content management system 100 may provide synchronization of files managed by content management system 100. Attributes 112a and 112b (collectively 112) or other metadata may be stored with files 110. For example, a particular attribute may be stored with the file to track files locally stored on client devices 102 that are managed and/or synchronized by content management system 100. In some embodiments, attributes 112 may be implemented using extended attributes, resource forks, or any other implementation that allows for storing metadata with a file that is not interpreted by a file system. In particular, an attribute 112a and 112b may be a content identifier for a file. For example, the content identifier may be a unique or nearly unique identifier (e.g., number or string) that identifies the file.

By storing a content identifier with the file, a file may be tracked. For example, if a user moves the file to another location within the file system 108 hierarchy and/or modifies the file, then the file may still be identified within the local file system 108 of a client device 102. Any changes or modifications to the file identified with the content identifier may be uploaded or provided for synchronization and/or version control services provided by the content management system 100.

A stand-alone content management application 114a and 114b (collectively 114), client application, and/or third-party application may be implemented to provide a user interface for a user to interact with content management system 100. Content management application 114 may expose the functionality provided with content management interface 104 and accessible modules for device 102. Web browser 116a and 116b (collectively 116) may be used to display a web page front end for a client application that may provide content management 100 functionality exposed/provided with content management interface 104.

Content management system 100 may allow a user with an authenticated account to store content, as well as perform management tasks, such as retrieve, modify, browse, synchronize, and/or share content with other accounts. Various embodiments of content management system 100 may have elements, including, but not limited to, content management interface module 104, account management module 120, synchronization module 122, collections module 124, sharing module 126, file system abstraction 128, data store 118, and organization module 140. The content management service interface module 104 may expose the server-side or back end functionality/capabilities of content management system 100. For example, a counter-part user interface (e.g., stand-alone application, client application, etc.) on client electronic devices 102 may be implemented using content management service interface 104 to allow a user to perform functions offered by modules of content management system 100. In particular, content management system 100 may have an organization module 140 for identifying similar content items for clusters and samples of content items for presentation within user interfaces.

The user interface offered on client electronic device 102 may be used to create an account for a user and authenticate a user to use an account using account management module 120. The account management module 120 of the content management service may provide the functionality for authenticating use of an account by a user and/or a client electronic device 102 with username/password, device identifiers, and/or any other authentication method. Account information 130 may be maintained in data store 118 for accounts. Account information may include, but is not limited to, personal information (e.g., an email address or username), account management information (e.g., account type, such as “free” or “paid”), usage information, (e.g., file edit history), maximum storage space authorized, storage space used, content storage locations, security settings, personal configuration settings, content sharing data, etc. An amount of content management may be reserved, allotted, allocated, stored, and/or may be accessed with an authenticated account. The account may be used to access files 110 within data store 118 for the account and/or files 110 made accessible to the account that are shared from another account. Account module 120 may interact with any number of other modules of content management system 100.

An account may be used to store content, such as documents, text files, audio files, video files, etc., from one or more client devices 102 authorized on the account. The content may also include folders of various types with different behaviors, or other mechanisms of grouping content items together. For example, an account may include a public folder that is accessible to any user. The public folder may be assigned a web-accessible address. A link to the web-accessible address may be used to access the contents of the public folder. In another example, an account may include a photos folder that is intended for photos and that provides specific attributes and actions tailored for photos; an audio folder that provides the ability to play back audio files and perform other audio related actions; or other special purpose folders. An account may also include shared folders or group folders that are linked with and available to multiple user accounts. The permissions for multiple users may be different for a shared folder.

Content items (e.g., files 110) may be stored in data store 118. Data store 118 may be a storage device, multiple storage devices, or a server. Alternatively, data store 118 may be cloud storage provider or network storage accessible via one or more communications networks. Content management system 100 may hide the complexity and details from client devices 102 by using a file system abstraction 128 (e.g., a file system database abstraction layer) so that client devices 102 do not need to know exactly where the content items are being stored by the content management system 100. Embodiments may store the content items in the same folder hierarchy as they appear on client device 102. Alternatively, content management system 100 may store the content items in various orders, arrangements, and/or hierarchies. Content management system 100 may store the content items in a network accessible storage (SAN) device, in a redundant array of inexpensive disks (RAID), etc. Content management system 100 may store content items using one or more partition types, such as FAT, FAT32, NTFS, EXT2, EXT3, EXT4, ReiserFS, BTRFS, and so forth.

Data store 118 may also store metadata describing content items, content item types, and the relationship of content items to various accounts, folders, collections, or groups. The metadata for a content item may be stored as part of the content item and/or may be stored separately. Metadata may be store in an object-oriented database, a relational database, a file system, or any other collection of data. In one variation, each content item stored in data store 118 may be assigned a system-wide unique identifier.

Data store 118 may decrease the amount of storage space required by identifying duplicate files or duplicate chunks of files. Instead of storing multiple copies, data store 118 may store a single copy of a file 134 and then use a pointer or other mechanism to link the duplicates to the single copy. Similarly, data store 118 may store files 134 more efficiently, as well as provide the ability to undo operations, by using a file version control that tracks changes to files, different versions of files (including diverging version trees), and a change history. The change history may include a set of changes that, when applied to the original file version, produce the changed file version.

Content management system 100 may be configured to support automatic synchronization of content from one or more client devices 102. The synchronization may be platform independent. That is, the content may be synchronized across multiple client devices 102 of varying type, capabilities, operating systems, etc. For example, client device 102a may include client software, which synchronizes, via a synchronization module 122 at content management system 100, content in client device 102 file system 108 with the content in an associated user account. In some cases, the client software may synchronize any changes to content in a designated folder and its sub-folders, such as new, deleted, modified, copied, or moved files or folders. In one example of client software that integrates with an existing content management application, a user may manipulate content directly in a local folder, while a background process monitors the local folder for changes and synchronizes those changes to content management system 100. In some embodiments, a background process may identify content that has been updated at content management system 100 and synchronize those changes to the local folder. The client software may provide notifications of synchronization operations, and may provide indications of content statuses directly within the content management application. Sometimes client device 102 may not have a network connection available. In this scenario, the client software may monitor the linked folder for file changes and queue those changes for later synchronization to content management system 100 when a network connection is available. Similarly, a user may manually stop or pause synchronization with content management system 100.

A user may also view or manipulate content via a web interface generated and served by user interface module 104. For example, the user may navigate in a web browser to a web address provided by content management system 100. Changes or updates to content in the data store 118 made through the web interface, such as uploading a new version of a file, may be propagated back to other client devices 102 associated with the user's account. For example, multiple client devices 102, each with their own client software, may be associated with a single account and files in the account may be synchronized between each of the multiple client devices 102.

Content management system 100 may include sharing module 126 for managing sharing content and/or collections of content publicly or privately. Sharing module 126 may manage sharing independently or in conjunction with counterpart sharing module (e.g., 152a and 152b). Sharing content publicly may include making the content item and/or the collection accessible from any computing device in network communication with content management system 100. Sharing content privately may include linking a content item and/or a collection in data store 118 with two or more user accounts so that each user account has access to the content item. The sharing may be performed in a platform independent manner. That is, the content may be shared across multiple client devices 102 of varying type, capabilities, operating systems, etc. The content may also be shared across varying types of user accounts. In particular, the sharing module 126 may be used with the collections module 124 to allow sharing of a virtual collection with another user or user account. A virtual collection may be a grouping of content identifiers that may be stored in various locations within file system of client device 102 and/or stored remotely at content management system 100.

The virtual collection for an account with a file storage service is a grouping of one or more identifiers for content items (e.g., identifying content items in storage). An example of virtual collections is provided in commonly owned U.S. Provisional Patent Application No. 61/750,791, entitled “Presenting Content Items in a Collections View,” filed on Jan. 9, 2013, which is incorporated herein by reference in its entirety. The virtual collection is created with the collection module 124 by selecting from existing content items stored and/or managed by the file storage service and associating the existing content items within data storage (e.g., associating storage locations, content identifiers, or addresses of stored content items) with the virtual collection. By associating existing content items with the virtual collection, a content item may be designated as part of the virtual collection without having to store (e.g., copy and paste the content item file to a directory) the content item in another location within data storage in order to place the content item in the collection.

In some embodiments, content management system 100 may be configured to maintain a content directory or a database table/entity for content items where each entry or row identifies the location of each content item in data store 118. In some embodiments, a unique or a nearly unique content identifier may be stored for each content item stored in the data store 118.

Metadata may be stored for each content item. For example, metadata may include a content path that may be used to identify the content item. The content path may include the name of the content item and a folder hierarchy associated with the content item (e.g., the path for storage locally within a client device 102). In another example, the content path may include a folder or path of folders in which the content item is placed as well as the name of the content item. Content management system 100 may use the content path to present the content items in the appropriate folder hierarchy in a user interface with a traditional hierarchy view. A content pointer that identifies the location of the content item in data store 118 may also be stored with the content identifier. For example, the content pointer may include the exact storage address of the content item in memory. In some embodiments, the content pointer may point to multiple locations, each of which contains a portion of the content item.

In addition to a content path and content pointer, a content item entry/database table row in a content item database entity may also include a user account identifier that identifies the user account that has access to the content item. In some embodiments, multiple user account identifiers may be associated with a single content entry indicating that the content item has shared access by the multiple user accounts.

To share a content item privately, sharing module 126 may be configured to add a user account identifier to the content entry or database table row associated with the content item, thus granting the added user account access to the content item. Sharing module 126 may also be configured to remove user account identifiers from a content entry or database table rows to restrict a user account's access to the content item. The sharing module 126 may also be used to add and remove user account identifiers to a database table for virtual collections.

To share content publicly, sharing module 126 may be configured to generate a custom network address, such as a uniform resource locator (URL), which allows any web browser to access the content in content management system 100 without any authentication. To accomplish this, sharing module 126 may be configured to include content identification data in the generated URL, which may later be used to properly identify and return the requested content item. For example, sharing module 126 may be configured to include the user account identifier and the content path in the generated URL. Upon selection of the URL, the content identification data included in the URL may be transmitted to content management system 100 which may use the received content identification data to identify the appropriate content entry and return the content item associated with the content entry.

To share a virtual collection publicly, sharing module 126 may be configured to generate a custom network address, such as a uniform resource locator (URL), which allows any web browser to access the content in content management system 100 without any authentication. To accomplish this, sharing module 126 may be configured to include collection identification data in the generated URL, which may later be used to properly identify and return the requested content item. For example, sharing module 126 may be configured to include the user account identifier and the collection identifier in the generated URL. Upon selection of the URL, the content identification data included in the URL may be transmitted to content management system 100 which may use the received content identification data to identify the appropriate content entry or database row and return the content item associated with the content entry or database TOW.

In addition to generating the URL, sharing module 126 may also be configured to record that a URL to the content item has been created. In some embodiments, the content entry associated with a content item may include a URL flag indicating whether a URL to the content item has been created. For example, the URL flag may be a Boolean value initially set to 0 or false to indicate that a URL to the content item has not been created. Sharing module 126 may be configured to change the value of the flag to 1 or true after generating a URL to the content item.

In some embodiments, sharing module 126 may also be configured to deactivate a generated URL. For example, each content entry may also include a URL active flag indicating whether the content should be returned in response to a request from the generated URL. For example, sharing module 126 may be configured to only return a content item requested by a generated link if the URL active flag is set to 1 or true. Changing the value of the URL active flag or Boolean value may easily restrict access to a content item or a collection for which a URL has been generated. This allows a user to restrict access to the shared content item without having to move the content item or delete the generated URL. Likewise, sharing module 126 may reactivate the URL by again changing the value of the URL active flag to 1 or true. A user may thus easily restore access to the content item without the need to generate a new URL.

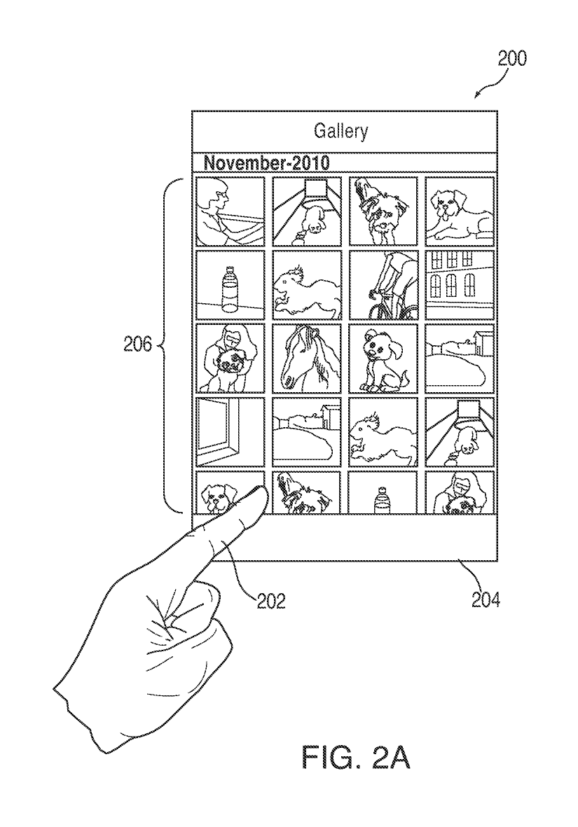

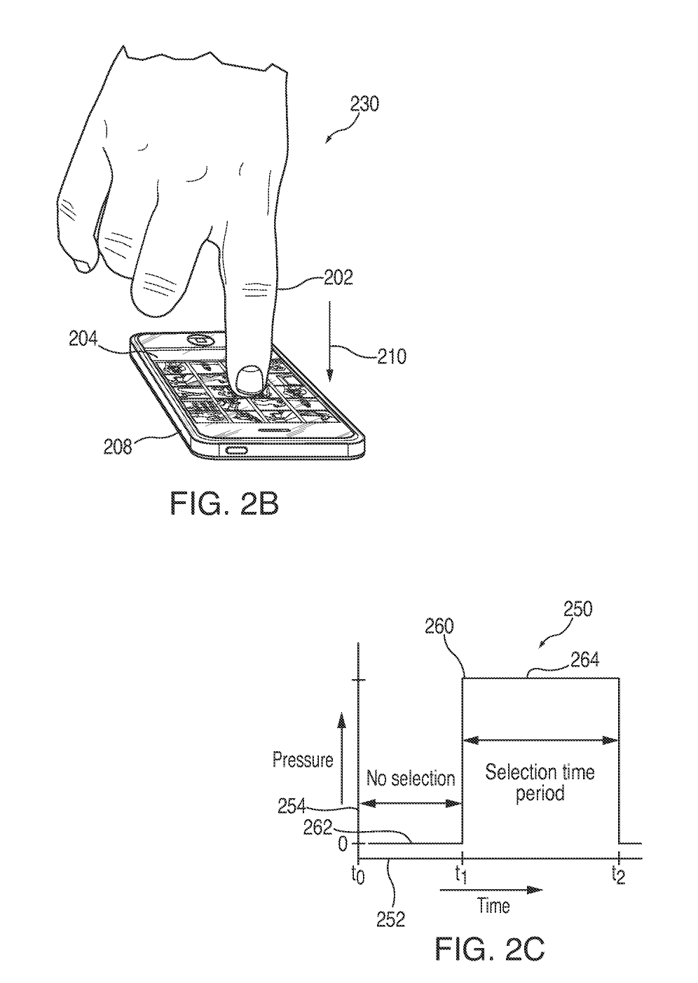

FIG. 2A is a schematic illustration of a user interface display in accordance with various embodiments. Display 200 may include content items 206 displayed on touch-sensing display interface 204. Content items 206 may include any content item that may be stored locally on a client device (e.g., client devices 102), remotely on a content management system (e.g., content management system 100), externally on an external storage device, or any combination thereof. For example, content items 206 may be photographs stored locally on a user device. As another example, content items 206 may be text documents, presentation documents, spreadsheet documents, or any other type of document. As still another example, content items 206 may be digital music files (e.g., mp3 files) stored locally on a user device, or remotely on a music player, for example, whose contents may be manipulated and/or visible on a remote device. Touch-sensing display interface 204 may be any display interface capable of displaying content and receiving gestures. Various touch-sensing display interfaces may include, but are not limited to, liquid crystal displays (LCD), monochrome displays, color graphics adapter (CGA) displays, enhanced graphics adapter (EGA) displays, variable-graphics array (VGA) displays, or any other display, or any combination thereof. In some embodiments, the touch-sensing display interface may include a multi-touch panel coupled to one or more processors to receive gestures. Multi-touch panels, for example, may include capacitive sensing mediums having a plurality of row traces or driving line traces, and a plurality of column traces or sensing lines. Although multi-touch panels are described herein as one example for touch-sensing display interface, it should be understood that any touch-sensing display interface known to those skilled in the art may be used.

In some embodiments, the number of content items 206 displayed on touch-sensing display interface 204 may be very large, and a user may want to share, edit, and/or view a smaller subset of content items. In this scenario, a user may interact with touch-sensing display interface 204 with a particular gesture to engage a “selection mode.” In the “selection mode,” the user may select one or more content items from displayed content items 206 and place those selected content items in a subset. In some embodiments, a user may execute a “long press” on touch-sensing display interface 204 to engage the selection mode. The long press may have the user touch or press upon the touch screen for a specific period of time, thus engaging the selection mode. The specific period of time may be any amount of time and may be differentiated from a gesture which may not be intended to engage the selection mode. For example, the specific period of time may be such so as to differentiate between a user who touches the touch-sensing display interface for an extended period of time but does not intend to engage the selection mode and a user who does intend to engage the selection mode. The user may touch or press upon the touch-sensing display interface with any object, which may include, but is not limited to, one or more of the user's fingers 202, a stylus, a computer accessible pen, a hand, or any other object capable of interfacing with the touch-sensing display interface, or any combination thereof.

FIG. 2B is a perspective top view of a user actuating a touch-sensing display interface in accordance with various embodiments. View 230 includes touch-sensing display interface 204 located on an upper side of client device 208 (e.g., client electronic device 102 of FIG. 1). View 230 also includes an object, such as finger 202. Finger 202 may push downwards (in the direction of arrow 210) to contact touch-sensing display interface 204. In some embodiments, finger 202 may contact touch-sensing display interface for a specific period of time, thereby engaging a selection mode on device 208. For example, finger 202 may provide a long press to touch-sensing display interface 204. Although side view 230 shows finger 202 contacting touch-sensing display interface 204, it should be noted that any object capable of contacting touch-sensing display interface 204 may be used. For example, one or more fingers, a stylus, or any other object capable of contacting touch-sensing display interface 204 may be used in conjunction with, or opposed to, finger 202, as noted above.

FIG. 2C is a graphical illustration of a gesture or action used to engage a selection mode in accordance with various embodiments. Graph 250 is a two-dimensional plot including axes 252 and 254, where axis 252 is the time axis, and points along it correspond to points in time. Axis 254 is the pressure axis, and points along it correspond to various amounts of pressure applied to touch-sensing display interface 204.

Graph 250 provides a graphical illustration of a gesture detected with touch-sensing display interface 204 to engage a selection mode. Line 260 illustrates the change in pressure detected by touch-sensing display interface 204 over time. Line 260 begins at time t₀ at zero-pressure, which corresponds to a time prior to any gesture being performed. At time t₁, the pressure is applied, and touch-sensing display interface 204 may detect a gesture. In some embodiments, the pressure detected at time t₁ may remain constant until time t₂ when the pressure may no longer be applied. In some embodiments, the pressure may fluctuate and/or be non-linear between t₁ and t₂. The region between t₁ and t₂ may be referred to as selection time period 264 and may be any defined amount of time. For example, selection time period may be two (2) seconds, five (5) seconds, ten (10) seconds, or any other suitable amount of time. When an object (e.g., finger 202) applies pressure to touch-sensing display for selection time period 264, the selection mode may be initiated. In some embodiments, selection time period 264 may be a period of time where the pressure detected by touch-sensing display interface remains constant. In some embodiments, the selection time period 264 may allow for variances in the amount of pressure detected by touch-sensing display interface. For example, an object may contact touch-sensing display interface 204, however over the course of selection time period 264, the amount of pressure may lessen, increase, or oscillate. In this scenario, a variance threshold may be defined to allow pressure fluctuations to be detected and still count as occurring during the selection time period 264. In this way, a user does not need to worry about ensuring precise constant pressure to engage the selection mode.

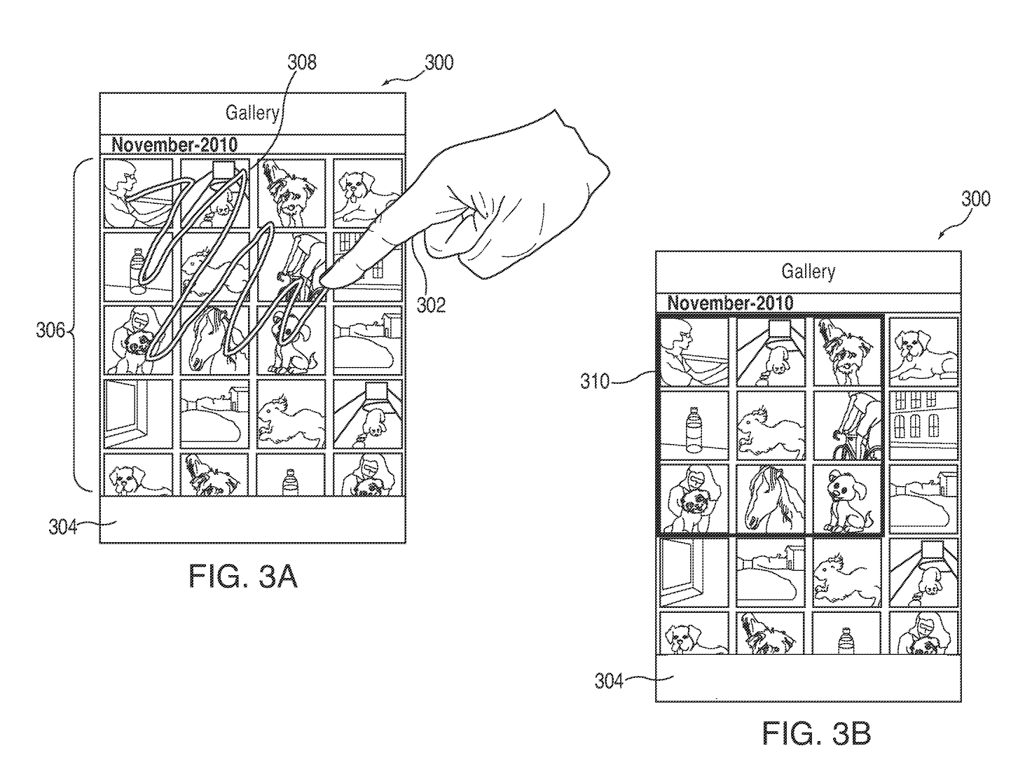

FIG. 3A is a schematic illustration of a user interface display in accordance with various embodiments. Display 300 may include content items 306 displayed on touch-sensing display interface 304. Content items 306 and touch-sensing display interface 304 of FIG. 3A may be substantially similar to content items 206 and touch-sensing display interface 204 of FIG. 2A, and the previous description of the latter may apply to the former.

Once a user engages a selection mode, gestures may be performed while in that mode to select a subset of content items from the displayed content items 306. In some embodiments, a user may swipe finger 302 about touch-sensing display interface 304 to select one or more content items. In some embodiments, the swipe may trace line 308. Content items that may be swiped by line 308 may be selected and placed in a subset of content items. In some embodiments, line 308 may be a virtual line. For example, line 308 may not appear on touch-sensing display interface 304, however the content items swiped by line 308 may still be included in the subset of content items. In some embodiments, line 308 may be displayed so as to be visible. For example, as finger 302 swipes over one or more content items, line 308 may be traced and displayed “on-top” of the one or more content items allowing the user to visualize the path of the line and the content items subsequently selected.

FIG. 3B is a schematic illustration of a user interface display in accordance with various embodiments. Display 300 may include subset of content items 310 displayed on touch-sensing display interface 304. As finger 302 swipes line 308 about content items 306, one or more content items may be selected and placed in subset 310. In some embodiments, the one or more content items may be immediately selected and placed in the subset as finger 302 swipes about the content items. In some embodiments, the one or more content items may be selected and then placed in the subset after the swiping motion is complete (e.g., once finger 302 is no longer in contact with touch-sensing display interface 304). In some embodiments, one or more actions may performed with the subset of content items via a subsequent gesture or user signal. For example, subset 310 may be shared using a content management system (e.g., content management system 100 of FIG. 1), edited (e.g., removing one or more content items), and/or finalized (e.g., turned into a photo gallery).

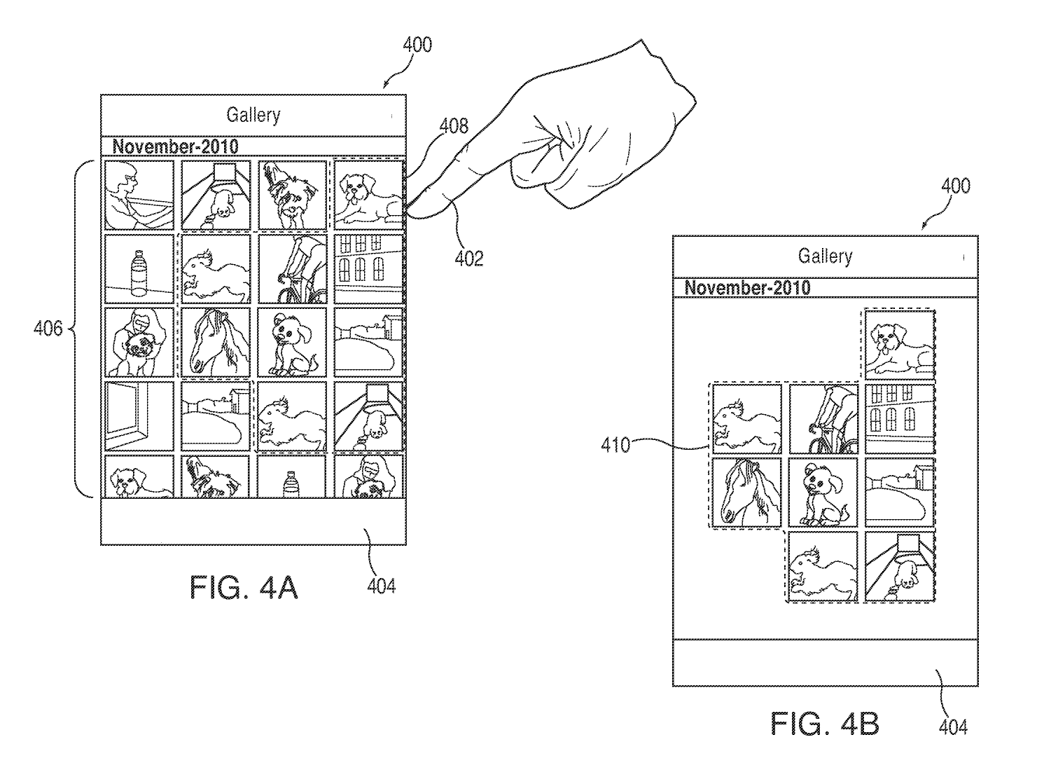

FIG. 4A is a schematic illustration of a user interface display in accordance with various embodiments. Display 400 may include content items 406 displayed on touch-sensing display interface 404. Content items 406 and touch-sensing display interface 404 may be substantially similar to content items 206 and touch-sensing display interface 204 of FIG. 2A, and the previous description of the latter may apply to the former.

FIG. 4B is a schematic illustration of a user interface display in accordance with various embodiments. Once a selection mode has been engaged (e.g., long press), one or more content items from displayed content items 406 may be selected and placed in subset 410. In some embodiments, an object, such as finger 402, may swipe an encompassing or “lassoing” line 408 around one or more of content items 406 to be selected. In some embodiments, line 408 may form a closed loop around the one or more content items and each content item enclosed by the loop may be placed in the subset. In some embodiments, the closed loop may form a perimeter around the one or more content items. However, in some embodiments finger 402 may swipe an incomplete loop and touch-sensing display interface 404 may recognize that line 408 does not form a completed loop. In response, one or more algorithms running on the corresponding user device associated with touch-sensing display interface 404 may automatically complete the loop. Once the loop has been completed, the one or more content items enclosed by the loop may be placed in the subset (e.g., subset 410).

In some embodiments, line 408 may not form a perimeter around the content items, but may run “through” the one or more content items intended to be selected. In this scenario, the content items that are enclosed by line 408 as well as the content items that line 408 “touches” may be selected and placed in subset 410. These rules are understood to be merely exemplary, and any rule or rules may be applied regarding the formation of line 408 to generate the desired subset of content items. In some embodiments, finger 402 may swipe over two or more adjacent content items. For example, two content items that may both be swiped by finger 402 may both content items may be selected and placed in the subset automatically. As another example, if a swipe encloses a certain percentage (e.g., 25%, 50%, etc.) of a content item then that content item may be selected and placed in the subset.

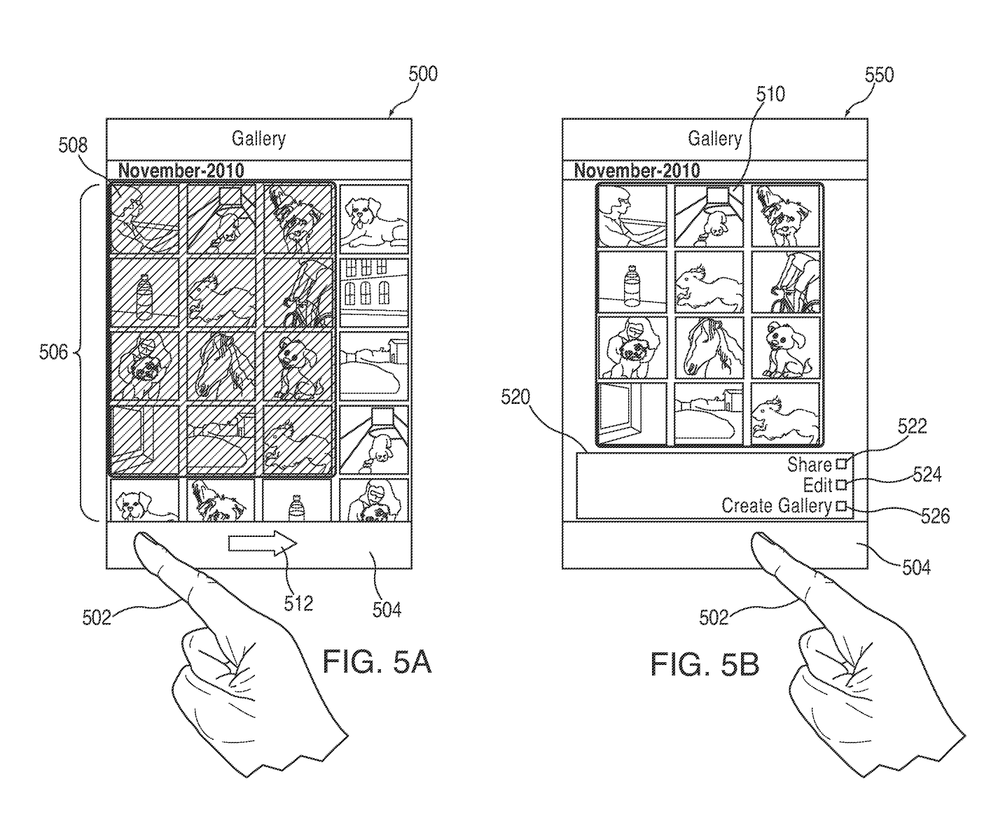

FIG. 5A is a schematic illustration of a user interface display in accordance with various embodiments. Display 500 may include content items 506 displayed on touch-sensing display interface 504. Content items 506 and touch-sensing display interface 504 may be substantially similar to content items 206 and touch-sensing display interface 204 of FIG. 2A, and the previous description of the latter may apply to the former. Display 500 may also include subset 508. Subset 508 may be a subset of content items that have been selected from displayed content items 506 via one or more gestures. For example, a user may engage in a selection mode by providing a long press to touch-sensing display interface 504 and, after the selection mode has been engaged, swipe finger 502 about the one or more content items, selecting and placing the content items in subset 508.

In some embodiments, once subset 508 has been generated, one or more further actions may be performed upon it. For example, a user may perform a swiping gesture so as to present subset 508 in a display that no longer includes the content items 506. For example, the user may swipe finger 502 across touch-sensing display interface 504 in the direction of arrow 512. By swiping finger 502 across touch-sensing display interface 504, subset 508 may be placed in a separate viewing screen. It is, of course, understood that any gesture may be performed to place subset 508 in the separate viewing screen and the use of a swiping motion is merely exemplary. Thus, in alternate embodiments, a user may, for example, perform a flicking motion on touch-sensing display interface 504 (e.g., a short and quick impulse), speak a command, shake the device, tap touch-sensing display interface 504, provide an input to an auxiliary input device (e.g., a headset with an input option), or any other gesture, or any combination thereof.

FIG. 5B is a schematic illustration of a user interface display in accordance with various embodiments. Display 550 may include a new display screen presented by touch-sensing display interface 504 after a previous action and/or gesture has been performed (e.g., swiping of finger 502 in direction 512 as shown in FIG. 5A). Display 550 may display isolated subset 510 (essentially subset 508) and not display any content items that were not selected from content items 506. In some embodiments, isolated subset 510 may be displayed on the same display screen that originally displayed content items 506, however the unselected content items may be removed. For example, a user may swipe finger 502 on touch-sensing display interface 504 in the direction of arrow 512 and in response the unselected content items may be removed from display on touch-sensing display interface 504.

In some embodiments, in response to the gesture and/or action performed, one or more options may be presented to the user on touch-sensing display interface 504. For example, after finger 502 swipes across touch-sensing interface 504, pop-up notification 520 may automatically appear. In some embodiments, pop-up notification 520 may include one or more options that may be performed to/with isolated subset 510. For example, pop-up notification 520 may include sharing options, editing options, gallery creation options, playlist creation options, messaging options, email options, privacy setting options, or any other option, or any combination thereof.

Pop-up notification 520 may include a “Share” option 522, an “Edit” option 524, and/or a “Create Gallery” option 526, for example. Although pop-up notification 520 only includes three options, it should be understood that any number of options may be included. In some embodiments, share option 522 may share isolated subset 510 between one or more contacts using a content management system. For example, selection of share option 522 may allow subset 510 to be uploaded to content management system 100 via first client electronic device 102a, and shared with contacts associated with the user of device 102a (e.g., second client electronic device 102b). As another example, selecting share option 522 may provide a URL link that may be included in an email and/or a text message to allow one or more contacts to view subset 510. As still yet another example, selection of share option 522 may allow subset 510 to be shared on one or more social networking services.

In some embodiments, specific gestures may correspond to content being automatically shared. For example, sharing of subset 510 may automatically occur in response to finger 502 being swiped across touch-sensing display interface 504 at the bottom of FIG. 5B. As another example, swiping two fingers across touch-sensing display interface 504 may automatically share subset 508. In this particular example, pop-up notification may not appear because an action (e.g., sharing) has already occurred.

Continuing with reference to FIG. 5B, edit option 524 may allow a user to edit or modify one or more content items from subset 510 using any suitable means. In some embodiments, edit option 524 may include providing an additional gesture to remove one or more content items from subset 510 (e.g., a crisscross “X” gesture, a squiggly deletion symbol, as used in conventional editor's marks, a strikethrough gesture, or the like) and/or add one or more content items to subset 510. For example, after creation of subset 510, the user may remove one or more content items which may have been erroneously included in the selection process and/or remove one or more content items which the user may have initially desired, but no longer wants, to include in subset 510. For instance, if a user selects content items by swiping a line about one or more content items, a line may appear (e.g., line 308 of FIG. 3A) indicating the selected content items. After the subset has been created, the user may enter into an additional mode (e.g., via an additional long press), which may allow the user to erase portions of the line. Alternatively, the user may erase portions of the line after forming the line, but prior to creation of the subset. As yet another example, after creation of subset 510, one or more content items may be added to subset 510. Additional content items from the displayed content items 506 may be added to subset 510 using any suitable gesture including, but not limited to, tapping, swiping, pinching, and/or speaking a command. In some embodiments, edit option 524 may allow a user to modify one or more content items included in subset 510. For example, one or more content items may be cropped, color adjusted, have a filter applied to, rotated, or any other editing option, or any combination thereof.

Create gallery option 526 may allow a user to create a gallery, playlist, and/or a slideshow based on subset 510. For example, if subset 510 includes photos, create gallery option 526 may allow the user to create a photo gallery from subset 510. As another example, if subset 510 includes music files, create gallery option 526 may allow the user to create a playlist from subset 510. As yet another example, if subset 510 includes images, such as slides or presentation materials, create gallery option 526 may allow the user to create a slideshow from subset 510. In some embodiments, separate options may be included in pop-up notification 520 for creating a photo gallery, a playlist, and/or a slideshow, and these options may not all be included in create gallery option 526.

In some embodiments, providing a specific gesture, such as swiping finger 502 across touch-sensing display interface 504 in the direction of arrow 512, may automatically perform an action on subset 508. For example, a user may perform a “flick” on touch-sensing display interface 504 enabling an automatic sharing. In this scenario, one or more sharing rules may be defined so that if a flick is detected with touch-sensing display interface 504, the sharing protocol may be performed. In some embodiments, performing a flick may cause one or more separate/additional actions. For example, performing a flick may cause subset 508 to automatically be placed in an email or text message. As another example, performing a flick may automatically upload subset 508 to one or more social media networks. In some embodiments, predefined rules may require authorization after a flick occurs to ensure sharing security. In still further embodiments, various additional gestures may cause an action to occur on subset 508, such as automatic sharing. For example, flicking, pinching, swiping with one or more fingers, vocal commands, motion tracking, or any other gesture, or any combination thereof, may allow for the action to be performed. In this way, quick and easy actions, such as sharing of subset 508, may be performed in an effortless manner.

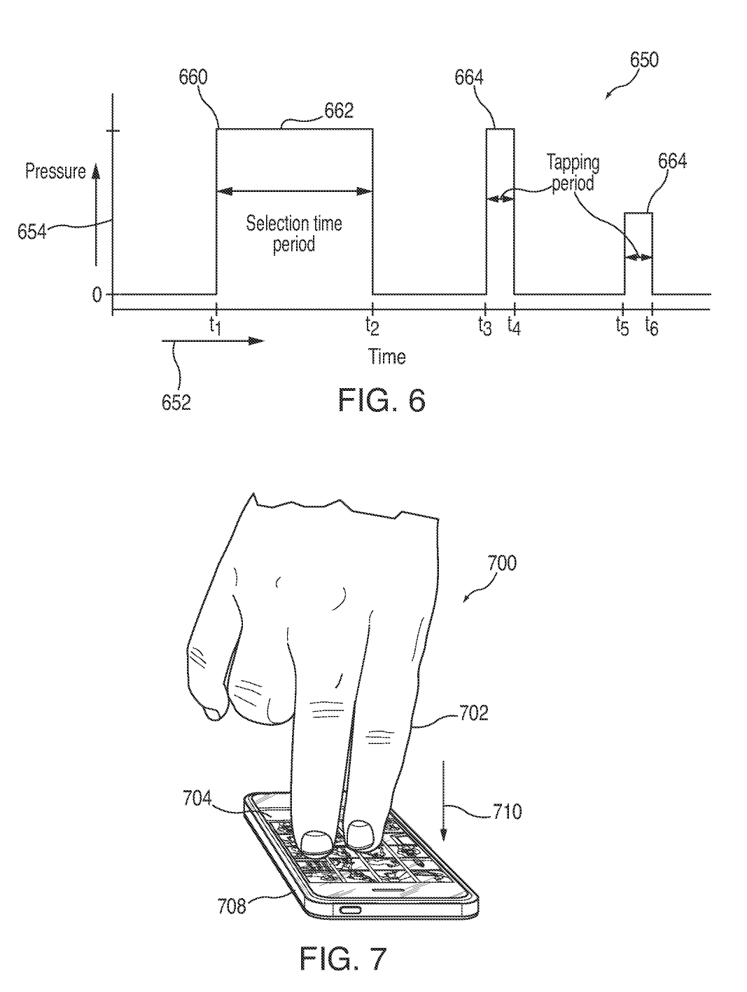

FIG. 6 is a graphical illustration of exemplary gestures engaging a selection mode and selecting content items in accordance with various embodiments. Graph 650 is a two-dimensional graph of pressure over time, with pressure axis 654 and time axis 652 corresponding to the y and x axes respectively.

Graph 650 includes line 660 which represents the pressure detected by touch-sensing display interface (e.g., touch-sensing display interface 204 of FIG. 2). A user may contact a touch-sensing display interface using one or more objects (e.g., finger(s), stylus, etc.) to engage a selection mode and, once engaged, select and place one or more content items in a subset of content items. In some embodiments, line 660 may require a zero pressure reading prior to any contact being detected with the touch-sensing display interface. In other embodiments, a higher “zero” pressure may be used.

In some embodiments, the touch-sensing display interface may detect a first gesture at time t₁. For example, a user may place one or more objects, such as a finger 202, on the touch-sensing display interface. In some embodiments, the touch-sensing display interface may detect that the first gesture no longer contacts the touch-sensing display interface at time t₂. For example, a user may place a finger on touch-sensing display interface at time t₁ and remove or substantially remove the finger at time t₂. In some embodiments, the period of time between t₁ and t₂ may engage a selection mode and may be referred to as selection time period 662. Selection time period 662 may be any period of time that engages the selection mode allowing selection of one or more content items from a plurality of content items displayed on the touch-sensing display interface (e.g., a long press). For example, selection time period 662 may be 2 seconds, 5 seconds, or any other time period capable of engaging the selection mode.

Once the selection mode has been engaged, line 660 may return back to a nominal level indicating that contact may no longer be detected with the touch-sensing display interface. For example, if a long press is used to engage the selection mode, after selection time period 662 a user may remove their finger from the touch-sensing display interface and the selection mode may remain engaged.

Engaging the selection mode may allow the user to select and place one or more content items from the plurality of content items displayed on the touch-sensing display interface in the subset of content items. As noted, the selection and placement of the content items may occur via one or more gestures detected with the touch-sensing display interface. For example, a user may tap one or more displayed content items to select and place the content item(s) in the subset. In additional examples, the user may swipe, pinch, flick, speak a command, or provide any other gesture, or any combination of such inputs, to select and place the one or more content items in the subset.

In some embodiments, at time t₃ the touch-sensing display interface may detect a gesture, such as a tap. The tap may include detection of an object, such as a finger, coming into contact with the touch-sensing display interface. In some embodiments, the tap may end at time t₄ when the touch-sensing display interface no longer detects the object. In some embodiments, the time between t₃ and t₄ may be referred to as tapping period 664. Tapping period 664 may be any period of time capable of allowing a content item to be selected. In some embodiments, tapping period 664 may be substantially smaller than selection time period 662. For example, if selection time period 662 corresponds to an object contacting the touch-sensing display interface for 3 seconds, tapping period 664 may correspond to the object contacting the touch-sensing display interface for 1 second. This is merely exemplary and any convenient time interval may be associated with the selection time period and the tapping period.

In some embodiments, the touch-sensing display interface may detect multiple taps, such as a tapping period between times t₅ and t₆. The tapping period between t₅ and t₆ may be substantially similar to the tapping period between t₃ and t₄ with the exception that the former may correspond to a tap that is detected with the touch-sensing display interface with less pressure than the latter. For example, the user may select one or more content items with a long or hard tap (e.g., t₃ and t₄), or a quick or soft tap (e.g., t₅ and t₆). Furthermore, although line 660 only shows two tapping periods 664, it should be understood that any number of taps may be included to select any amount of content items.

In some embodiments, tapping period 664 may correspond to one or more gestures different than a tap. For example, tapping period 664 may correspond to the time period needed to perform a swipe of one or more content items. In some embodiments, tapping period 664 may correspond to a tap and one or more additional gestures. For example, a first tapping period between t₃ and t₄ may correspond to a swipe whereas a second tapping period between t₅ and t₆ may correspond to a tap.

In some embodiments, tapping period 664 may be a greater amount of time than selection time period 662. For example, if the user is selecting one or more content items using an intricate swipe (e.g., a swipe depicted by line 408 of FIG. 4), the swipe may take longer to complete than selection time period 662. In this scenario, one or more modules on the user device may detect a difference between the gestures and differentiate between the gesture that engages the selection mode and the gesture that selects content items. In still further embodiments, if the time between selection time period 662 and tapping period 664, or the time between two instances of tapping period 664, exceeds a threshold, the selection mode may end. For example, after a user engages the selection mode, the user may forget to tap a content item. If the elapsed time between t₂ and t₃ exceeds a threshold value, then the selection mode may end and a user may have to re-engage the selection mode to select content items. This may help prevent a user from accidently selecting content items if they have forgotten that they are currently in the selection mode, or if they have decided not to select anything after all. In still further embodiments, an additional gesture corresponding to exiting the selection mode may be detected.

FIG. 7 is a schematic illustration of a perspective side view of a user performing a gesture in accordance with various embodiments. View 700 may include device 708 and touch-sensing display interface 704. Device 708 and touch-sensing display interface 704 may be substantially similar to device 208 and touch-sensing display interface 204 of FIG. 2B, and the previous description of the latter may apply to the former. Fingers 702 may correspond to two or more fingers. Fingers 702 may come into contact with touch-sensing display interface 704 by pressing in a downward direction indicated by arrow 710. The direction of arrow 710 is merely exemplary, and any direction (e.g., up, down, left, right, etc.) may be used to describe the direction that fingers 702 contacts touch-sensing display interface 704.

In some embodiments, if touch-sensing display interface 704 detects contact from fingers 702, then a selection mode may automatically be engaged. For example, a user may contact touch-sensing display interface 704 using two fingers 702 (e.g., an index finger and a middle finger) and, in response, automatically engage the selection mode. As another example, a user may contact touch-sensing display interface 704 using three or more fingers and one or more modules may detect the three fingers contacting touch-sensing display interface 704 and may automatically engage the selection mode. In some embodiments, touch-sensing display interface 704 may detect fingers 702 and determine, using one or more modules on device 708, if fingers 702 correspond to an authorized user of device 702. For example, device 702 may have the fingerprints of the authorized user of device 708 stored in memory or a database. Various examples of fingerprint recognition technology are known in the art, and those so skilled may choose any convenient or desired implementation. In response to detecting fingers 702 contacting touch-sensing display interface 704, device 708 may perform any appropriate identification check to determine whether or not fingers 702 correspond to the authorized user. If it is determined that fingers 702 correspond to the authorized user then the selection mode may automatically be engaged. If it is determined that fingers 702 do not correspond to the authorized user then device 708 may take no action.

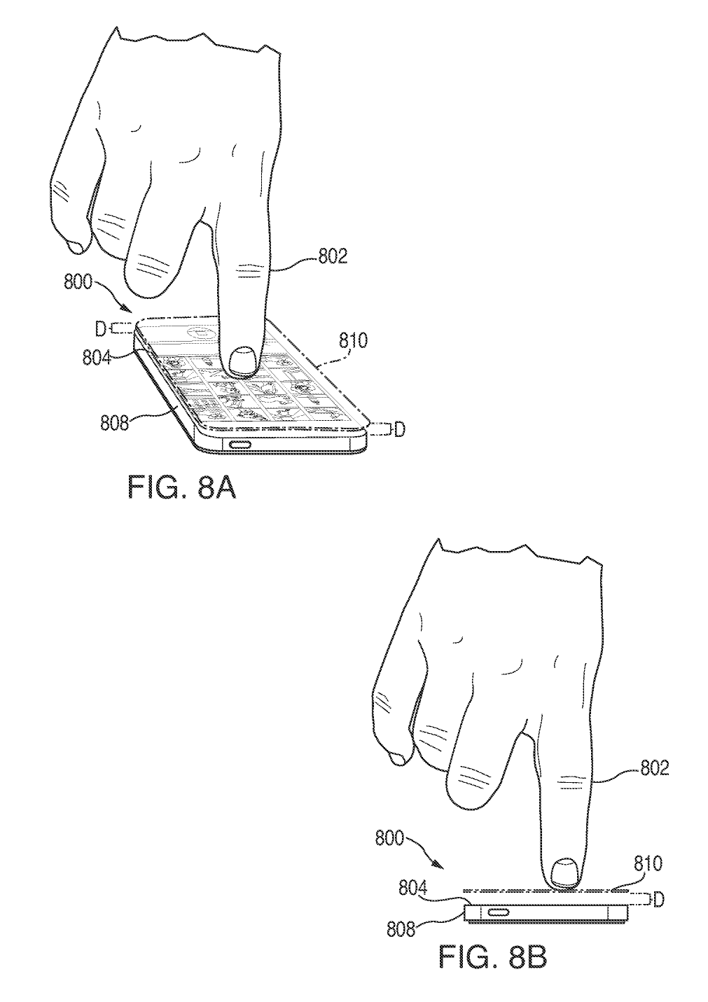

FIG. 8A is a schematic illustration of a similar view to that of FIG. 7 of a gesture in accordance with various embodiments. View 800 may include device 808 and touch-sensing display interface 804 which may be substantially similar to device 208 and touch-sensing display interface 204 of FIG. 2B, and the previous description of the latter may apply to the former. View 800 includes finger 802 performing a gesture. In some embodiments, finger 802 may hover a distance D over touch-sensing display interface 804 about hover plane 810. Hover plane 810 may be distance D above touch-sensing display interface 804. Distance D may be any distance that enables touch-sensing display interface 804 to detect the presence of finger 802. For example, distance D may range between 0.1 mm-10 mm, however any range of distances may be used. In some embodiments, more than one finger (e.g., two or more fingers), a stylus, or any other object operable to interact with the touch-sensing display interface may be used in place of, or in combination with, finger 802.

In some embodiments, finger 802 may hover above touch-sensing display interface 804, along hover plane 810, to engage a selection mode. For example, finger 802 may hover distance D above touch-sensing display interface 804 for a period of time (e.g., selection time period 662 of FIG. 6), to engage the selection mode. In some embodiments, one or more modules on device 808 may detect that finger 802 may be hovering distance D over touch-sensing display interface 804 and detect variations in distance D. Variations may occur for a multitude of reasons, for instance unsteadiness associated with hovering for a period of time. For example, device 808 may include a variance indicator that may detect if distance D changes by more or less than a predefined deviation Δ. Thus, while finger 802 hovers over touch-sensing display interface 804 along hover plane 810, finger 802 may in actuality hover between distances D+Δ and D−Δ and device 808 may detect the changes to allow engagement of the selection mode. If finger 802 changes its hover distance by more than D±Δ, then device 808 may detect the change and may not engage the selection mode.

In some embodiments, a user that engages a selection mode by hovering finger 802 above touch-sensing display interface 804 may also provide one or more additional gestures to select one or more contact items. In some embodiments, once the selection mode has been engaged, the user may hover over a content item for a period of time to select the content item. For example, a user may move finger 802 about a content item displayed on touch-sensing display interface 804 and hover finger 802 along hover plane 810 a distance D above the content item for a period of time to select that content item. The period of time that selects the content item may be more or less than the selection time period, but preferably less. In some embodiments, the user may hover over multiple content items, swipe while hovering, or provide any other gesture while hovering to select and place content items in a subset of content items as described above. In some embodiments, once engaged in the selection mode by hovering, a user may swipe, tap, flick or provide any other gesture to select a content item or items.

In some embodiments, a user that engages a selection mode by hovering finger 802 above touch-sensing display interface 804 may speak one or more commands to select and place one or more content items in a subset of content items. For example, once engaged in the selection mode, a user may use various voice commands to take subsequent action(s). Device 808 may include one or more modules that may be operable to receive the commands and transform them into one or more inputs in the selection mode. For example, a user may say “select all,” and device 808 may select and place all the displayed content items in the subset. By allowing selection and placement via voice commands, a distinct advantage is provided to individuals with disabilities, or to any other individual who may have difficulty providing one or more gestures to select content items.

FIG. 8B is a schematic illustration of a side view corresponding to FIG. 8A in accordance with various embodiments. View 800 includes finger 802 hovering about touch-sensing display interface 804 along hover plane 810. Hover plane 810 may be a distance D above touch-sensing display interface 804. Thus, finger 802 may move about hover plane 810 and perform various gestures which may be detected by touch-sensing display interface 804.

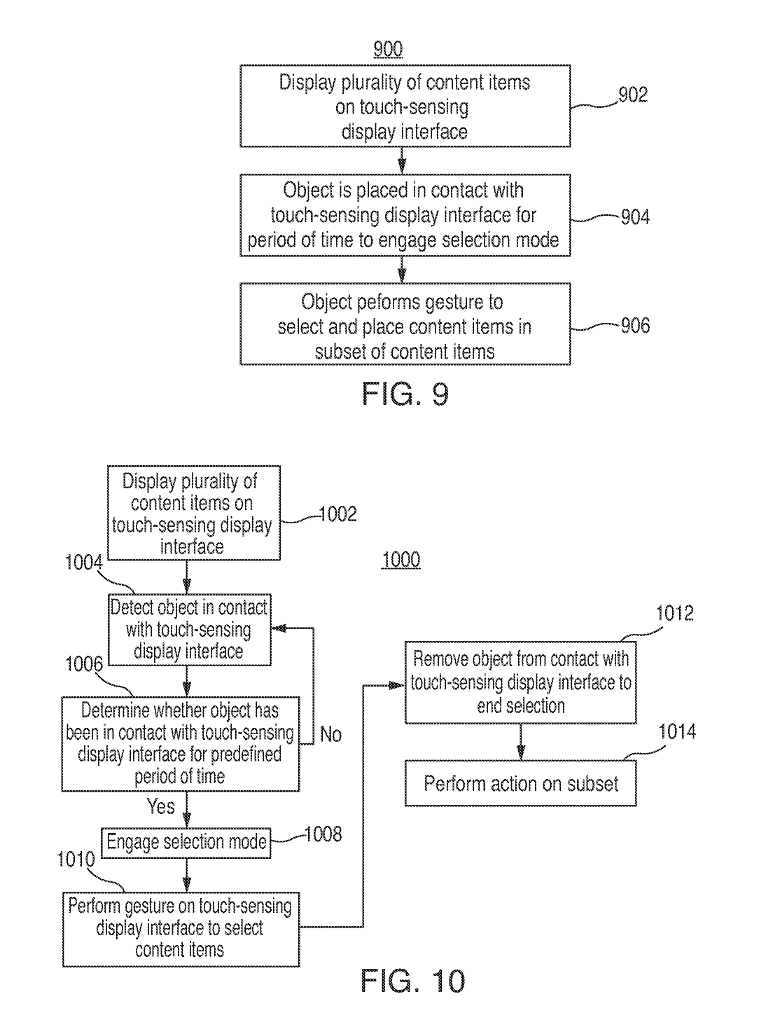

FIG. 9 is an illustrative flowchart of a process using gestures to select content items in accordance with various embodiments. Process 900 may begin at step 902. At step 902, a plurality of content items may be displayed on a touch-sensing display interface. For example, content items 206 may be displayed on touch-sensing display interface 204 of FIG. 2A. Content items may include photographs, music files (e.g., mp3s), videos, text documents, presentations, or any other file type, or any combination thereof. Various touch-sensing display interfaces may include, but are not limited to, liquid crystal displays (LCD), monochrome displays, color graphics adapter (CGA) displays, enhanced graphics adapter (EGA) displays, variable-graphics array (VGA) displays, or any other display, or any combination thereof. In some embodiments, the touch-sensing display interface may include a multi-touch panel coupled to one or more processors to receive gestures.

In some embodiments, the content items may be displayed on a display interface that may be connected to one or more gesture control devices. For example, content items may be displayed on a display device (e.g., a monitor), and the display may be connected to a touch-sensing interface. A user may contact the touch-sensing interface and perform gestures to interact with the content items displayed on the connected display device. As another example, content items may be displayed on a display device, and the display device may be connected to a motion-sensing interface. A user may gesture various motions which may be detected by the motion-sensing interface. The motion-sensing interface may then send instructions to the connected display to allow the user to interact with the content items displayed on the display device.

Process 900 may then proceed to step 904. At step 904, an object may be placed in contact with a touch-sensing display interface for a period of time to engage a selection mode. In some embodiments, the object may be one or more fingers, a stylus, and/or a computer compatible pen, or any other object capable of interacting with a touch-sensing display interface. For example, finger 202 of FIG. 2A may be placed in contact with touch-sensing display interface 204. In one particular example, finger 202 may press downwards to contact touch-sensing display interface 204 for selection time period 264 to engage a selection mode.

In some embodiments, one or more modules may determine whether or not the user applied object (e.g., finger 202) has remained in contact with the touch-sensing display interface for at least the time period required to engage the selection mode (e.g., selection time period 264). This may ensure that the user intends to engage the selection mode and is not performing another function or action. The selection time period may be any amount of time capable of differentiating between intended engagement of the selection mode and unintentional engagement of the selection mode. For example, the selection time period may be 1 second, 5 seconds, 10 seconds, 1 minute, or any other amount of time, preferably a few seconds. In some embodiments, the selection time period may be predefined by the user of a device corresponding to the touch-sensing display interface (e.g., device 208). For example, the user may input an amount of time to the device so that if an object contacts the touch-sensing display interface the selection time period as a setting, the selection mode may be engaged. In some embodiments, the selection time period may be defined by a content management system (e.g., content management system 100).

Process 900 may then proceed to step 906. At step 906, the object may perform a gesture to select one or more content items from the plurality of content items displayed on the touch-sensing display interface and place the selected one or more content items in a subset of content items. In some embodiments, the gesture performed may be a swipe. For example, finger 302 of FIG. 3 may swipe line 308 about content items 306 on touch-sensing display interface 304. The content items swiped by line 308 may be selected and placed in subset 310. As another example, finger 402 may swipe line 408 which forms a loop about content items 406 displayed on touch-sensing display interface 404 of FIG. 4, and the content items enclosed by line 408 may be selected placed in subset 410.

In some embodiments, the loop formed by line 408 may be a closed loop surrounding the perimeter of one or more displayed content items. Any content item that may be enclosed within the perimeter of the loop may be included in the subset. In some embodiments, the loop formed by line 408 may be a closed loop that runs through one or more content items. Any content item which may have the loop running through it may be included in the subset of content items along with any content items enclosed by the loop. In yet another embodiment, the loop formed by line 408 may not be a completed loop (e.g., not enclosed). In this scenario, one or more modules on the user device may use one or more algorithms to automatically complete the loop.

In some embodiments, the gestures may include tapping on one or more content items to select and place the content item(s) in the subset. For example, the user may tap on content items with a finger or any other object. The user may select each content item individually by tapping on touch-sensing display interface 204 with finger 202 to select and place the content items in the subset. In some embodiments, the gesture may include tapping on individual content items a first time to select and place them in the subset and tapping on the content items a second time to remove them from the subset.

In some embodiments, one or more indications may be presented to the user on the touch-sensing display interface to signify that the selection mode has been engaged. For example, after the selection mode has been engaged, the content items (e.g., content items 206 of FIG. 2A) may appear brighter than the corresponding background. As another example, the content items may “dance” or wiggle indicating that the content items are available for selection because the selection mode has been engaged. In still another example, they may blink at some frequency.

In some embodiments, an option may appear after the gesture is performed that may allow one or more actions to occur to the subset. For example, after selecting subset 508 of FIG. 5, finger 502 may swipe across touch-sensing display interface 504 in the direction of arrow 512 which may cause options to appear that allow the user to share, edit, and/or create a gallery based with subset 508. In some embodiments, swiping finger 502 in the direction of arrow 512 may cause pop-up notification 520 to appear. Pop-up notification 520 may include options that allow the user to share, edit, and/or create a gallery. In some embodiments, the pop-up notification may appear along with an isolated subset of content items. For example, isolated subset 510 may be substantially similar to subset 508 with the exception that the content items not selected may no longer be displayed on touch-sensing display interface 504.

In some embodiments, a specific action may be performed to the subset after the gesture. For example, after creation of the subset, the user may swipe a finger across the touch-sensing display interface allowing the subset to be shared. Swiping a finger, swiping multiple fingers, swiping an object, or any other gesture performed with any object may enable the subset to automatically be shared. Sharing may occur between one or more contacts associated with the user, the content management system, and/or one or more social media networks. In some embodiments, the specific action performed may move the subset to a separate viewing screen so only the subset and no other content items are viewed.

In some embodiments, options to perform one or more actions may automatically appear after creation of the subset. For example, after creation of subset 508, pop-up notification 520 may automatically appear. In some embodiments, one or more modules associated with the touch-sensing display interface may detect that the gesture that created the subset has ended and, in response, automatically provide various options to the user. For example, touch-sensing display interface 304 may detect when finger 302 initially comes into contact with the touch-sensing display interface as well as when finger 302 may no longer be in contact. In this scenario, upon determining that there may no longer be contact between finger 302 and touch-sensing display interface 304, various options (e.g., pop-up notifications, options to share, options to edit the subset, etc.) may appear.

In some embodiments, after creation of the subset, the object may gesture a flicking motion on the touch-sensing display interface. The flicking motion may have a specific action associated with it. For example, if the user provides the flicking motion to the touch-sensing display interface after the subset is created, the subset may automatically be shared. In this scenario, one or more rules may be predefined to specify how the subset may be shared upon detection of the flicking gesture. It should be understood, however, that any gesture may be performed with any object to provide an action to the subset after the creation of the subset, and the aforementioned examples are merely exemplary. For example, additional gestures may include pinching, swiping with more than one finger, gesturing a wave of a hand, or any other gesture may be used to perform an action on the subset. For more examples of gestures, please see the Appendix below.

FIG. 10 is an illustrative flowchart of a process that uses gestures to select content items in accordance with various embodiments. Process 1000 may begin at step 1002. At step 1002, a plurality of content items may be displayed on a touch-sensing display interface. For example, touch-sensing display interface 204 of FIG. 2 may display content items 206. Step 1002 may be substantially similar to step 902 of FIG. 9, and the previous description of the latter may apply to the former.

At step 1004, an object may be detected to come into contact with the touch-sensing display interface. In some embodiments, the object may apply pressure to the touch-sensing display interface. For example, the object may be a finger 202 of FIG. 2B and touch-sensing display interface 204 may detect that finger 202 applies pressure in the direction of arrow 210. In some embodiments, the object need not actually physically contact the touch-sensing display interface and may hover a distance above the touch-sensing display interface, as described above. For example, finger 802 of FIG. 8 may hover a distance D above touch-sensing display interface 804.

At step 1006, a determination may be made as to whether the object has been in contact with the touch-sensing display interface for a predefined period of time. For example, the predefined period of time may correspond to a selection time period, such as selection time period 264 of FIG. 2C. If at step 1006 it is determined that the object has not been in contact with the touch-sensing display interface for the predefined period of time, process 1000 may return to step 1004. At this point, the process may continue to monitor and detect objects coming into contact with the touch-sensing display interface. However, if at step 1006 it is determined that the object has been in contact with the touch-sensing display interface for the predefined period of time, then process 1000 may proceed to step 1008. At step 1008, a selection mode may be engaged. The selection mode may allow a user to select one or more content items displayed on touch-sensing display interface.

At step 1010, a gesture may be performed on the touch-sensing display interface to select one or more content items from the displayed content items. In some embodiments, the gesture may be performed using an object, which may be the same object detected to be in contact with the touch-sensing display interface for the predefined period of time to engage the selection mode. For example, if the object used to engage the selection mode is one finger, then the object that performs the gesture may also be a single finger. In some embodiments, the object detected to be in contact with the touch-sensing display interface for a predefined period of time to engage the selection may be different than the object used to perform the gestures. For example, the object used to engage in the selection mode may be one finger, whereas the object used to perform the gesture may be a stylus. As yet another example, a first finger (e.g., a thumb) may be used to engage the selection mode whereas a second finger (e.g., an index finger) may be used to perform the gesture to select content items. In this example, a multi-touch display interface would be configured to recognize, and distinguish between, multiple touches by the first finger and the second finger.

Once having entered the selection mode, any gesture may be performed to select the one or more content items. In some embodiments, a swipe may be performed by the object about the touch-sensing display interface to select the one or more content items. For example, the user may trace a line (e.g., line 308 of FIG. 3) over one or more content items displayed on a touch sensing display interface to select the content items. In some embodiments, the object may swipe a closed loop or a partially closed loop (e.g., line 408 of FIG. 4) as noted above. In other embodiments, the user may select content items by tapping about the content item display on the touch-sensing display interface. In some embodiments, the user may hover the object above the touch-sensing display interface for a period of time to select a content item. For example, a user may hover finger 802 of FIG. 8 above touch-sensing display interface 804 for a period of time to select the content item(s).

At step 1012, the object may be removed from contact with the touch-sensing display interface. In some embodiments, once the object no longer contacting the touch-sensing display interface, the selection mode may end and no more content items may be selected, while those content items that have been selected may be placed in the subset of content items. For example, if the user swipes a finger about one or more content items displayed on the touch-sensing display interface to select content items, once the finger no longer contacts the touch-sensing display interface, the selecting may end and the selected content items may be placed in the subset. As another example, if the user taps a finger about a content item display on a touch-sensing display interface, once the tapping gesture ends, the selection may end. In this scenario, selection may begin again if another tap is detected with the touch-sensing display interface. In some embodiments, the selection of content items may end when the touch-sensing display interface detects that the object no longer hovers about the content item. For example, device 808 may detect that finger 802 is no longer a distance D above the touch-sensing display interface 804, and correspondingly end the selection mode. As still yet another example, a time-out feature may be implemented that ends the selection mode after a predefined period of time has elapsed without any gesture being performed. In still a further example, a gesture may be performed that ends the selection mode (e.g., a tap on a specific region on the touch-sensing display interface, an “X” drawn in the air, etc.).

At step 1014, an action may be performed on the subset of content items. In some embodiments, the subset of content items may be shared. For example, sharing may occur between one or more contacts associated with the user, a content management system, and/or one or more social networks. In some embodiments, an additional gesture may be performed to invoke the action. For example, the user may flick or swipe the touch-sensing display interface about the subset and in response to detecting the flick or swipe, the subset may automatically be shared. In still further embodiments, an action may be performed to edit the subset of content items. For example, after the selection mode has ended, the user may determine that one or more content items should be added/removed from the subset. The user may perform any suitable action to add/remove the one or more content items to/from the subset (e.g., tapping, swiping, pinching, etc.).

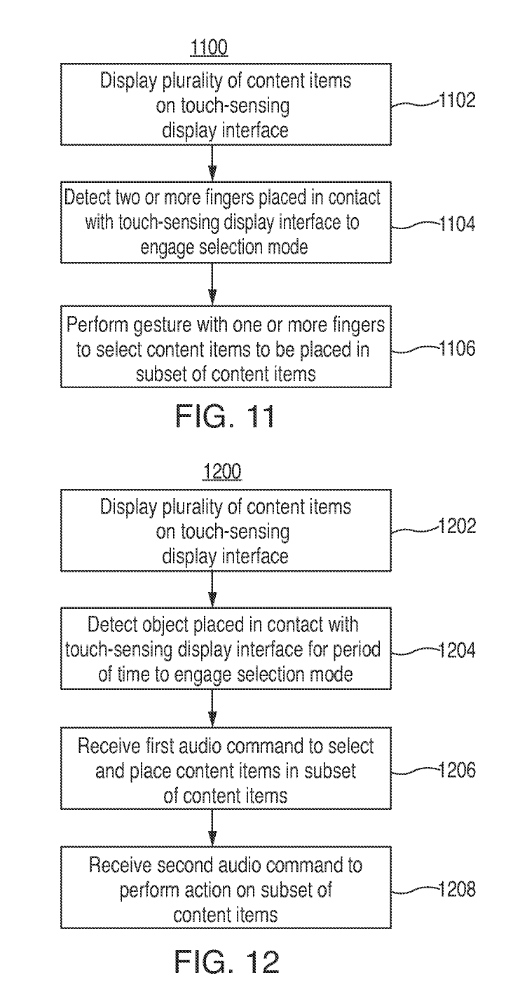

FIG. 11 is an illustrative flowchart of a process that uses gestures to select content items in accordance with various embodiments. Process 1100 may begin at step 1102. At step 1102, a plurality of contents may be displayed on a touch-sensing display interface. For example, content items 206 may be displayed on touch-sensing display interface 204 of FIG. 2A. Content items may include photographs, music files (e.g., mp3s), videos, text documents, presentations, or any other file type, or any combination thereof. The touch-sensing display interface may be any display screen capable of displaying content and receiving gestures. Step 1102 may be substantially similar to step 902 of FIG. 9, and the previous description of the latter may apply to the former.

At step 1104, two or more fingers may be placed in contact with the touch-sensing display interface to engage a selection mode. For example, fingers 702 of FIG. 7 may contact touch-sensing display interface 704 by applying downward pressure on the touch-sensing display interface. In some embodiments, one or more modules may determine whether or not the two or more fingers have remained in contact with the touch-sensing display interface for at least a defined time period required to engage the selection mode (e.g., selection time period 264). The period of time to engage the selection mode may be any amount of time and may be capable of differentiating between an intended engagement of the selection mode and unintentional contact. For example, the selection time period may be 1 second, 5 seconds, 10 seconds, 1 minute, or any other amount of time.

In some embodiments, upon detecting that the two or more fingers have come into contact with the touch-sensing display interface, the selection mode may automatically be engaged. For example, touch-sensing display interface 704 may detect that fingers 702 have come into contact with the touch-sensing display interface and may automatically engage the selection mode. In some embodiments, any number of fingers, appendages, or objects may be detected by the touch-sensing display interface to engage the selection mode. For example, touch-sensing display interface 704 may detect that three fingers have contacted the touch-sensing display interface and, upon detecting three fingers, automatically engage the selection mode. In yet another example, the touch-sensing display interface may detect a palm, four fingers, a thumb and another finger, or any other combination of fingers and, upon detection, automatically engage the selection mode.

In some embodiments, one or more modules may be capable of detecting that the two or more fingers correspond to an authorized user of the device associated with the touch-sensing display interface. For example, upon detecting fingers 702 contacting touch-sensing display interface 704, one or more modules on device 708 may detect the fingerprints associated with fingers 702. If the fingerprints are determined to correspond to the authorized user of device 708, the selection mode may be engaged automatically. However, if the fingerprints are determined to not correspond to the authorized user, the selection mode may not be engaged and one or more actions may occur. For example, in such an event the device may automatically lock.

Once the selection mode has been engaged, process 1100 may proceed to step 1106. At step 1106, a gesture may be performed with one or more fingers to select and place one or more content items in a subset of content items. For example, one finger, such as finger 302 of FIG. 3, may swipe about one or more content items to select and place the content items in subset 310. As another example, two or more fingers may swipe about one or more content items and select and place the content items in the subset. In some embodiments, the one or more fingers may perform a flick, tap, pinch, or any other gesture.

In some embodiments, after the one or more content items have been selected and placed in the subset of content items, an action may be performed on the subset. For example, one or more fingers may swipe across the touch-sensing display interface to automatically share the subset. As another example, one or more option may be presented to the user (e.g., a pop-up notification) which may allow a variety of actions to be performed on the subset (e.g., share, edit, create a gallery, etc.).

FIG. 12 is an illustrative flowchart of a process that uses a combination of gestures and audio commands to select content items in accordance with various embodiments. Process 1200 may begin at step 1202. At step 1202, a plurality of content items may be displayed on a touch-sensing display interface. For example, content items 206 may be displayed on touch-sensing display interface 204 of FIG. 2A. Content items may include photographs, music files (e.g., mp3s), videos, text documents, presentations, or any other file type, or any combination thereof. The touch-sensing display interface may be any display screen capable of displaying content and receiving gestures. In some embodiments, step 1202 may be substantially similar to step 902 of FIG. 9, and the previous description of the latter may apply to the former.

At step 1204, an object may be placed in contact with the touch-sensing display interface to engage a selection mode. In some embodiments, the object may be placed in contact with the touch-sensing display interface for a period of time to engage the selection mode (e.g., a selection time period 264). For example, in some embodiments step 1204 may be substantially similar to step 904 of FIG. 9, and the previous description of the latter may apply to the former. In some embodiments, two or more fingers may be placed in contact with the touch-sensing display interface to engage in the selection mode. For example, in some embodiments step 1204 may be substantially similar to step 1104 of FIG. 11, and the previous description of the latter may apply to the former.

Once the selection mode has been engaged, process 1200 may proceed to step 1206. At step 1206, a first audio command may be received to select and place one or more content items in a subset. In some embodiments, one or more microphones may be included in a device corresponding to the touch-sensing display interface and may be operable to detect audio commands. For example, this may be a standard feature of a mobile devices' operating systems (e.g., iOS, etc.). The one or more microphones may be operable to receive the audio commands and determine a corresponding action that may occur in response. Audio commands may be any command detected by the device which may be capable of generating a response. For example, a user may say “select all,” or “select first row.” In this scenario, a corresponding set of rules, implemented in a program or module stored on the device, may convert the received audio command to an action. By combining audio commands and gestures, a significant benefit may be provided to individuals who have difficulty interfacing solely with touch-sensing display interfaces, but may still desire to use touch-sensing display interfaces.

At step 1208, a second audio command may be received. The second audio command may allow various actions to occur to the subset of content items. For example, a user may say “share subset,” or “edit subset,” and one or more corresponding actions may occur. For example, if a user says “share subset” after creation of the subset, the subset may automatically be shared. In some embodiments, the user may provide additional audio commands. For example, the user may say “Share subset with content management system” and the subset may automatically be shared with the content management system.

In some embodiments, at step 1208 an additional gesture may be performed in combination with, or instead of, a second audio command. For example, a user may say “Edit subset” and the user may automatically be presented with the subset of content items and may provide any suitable gesture to edit the subset. In some embodiments, the user may tap on one or more content items within the subset to remove or edit the content item. As another example, the user may say “Share subset” and the touch-sensing display interface may present the user with audio and/or visual options such as “Share subset with content management system,” and/or “Share subset with a contact.” Furthermore, if the user says “Share subset,” an option may be provided to allow the user to select the destination of the share. This may aid in controlling the sharing of the subset so that it is not shared with an unintentional recipient.

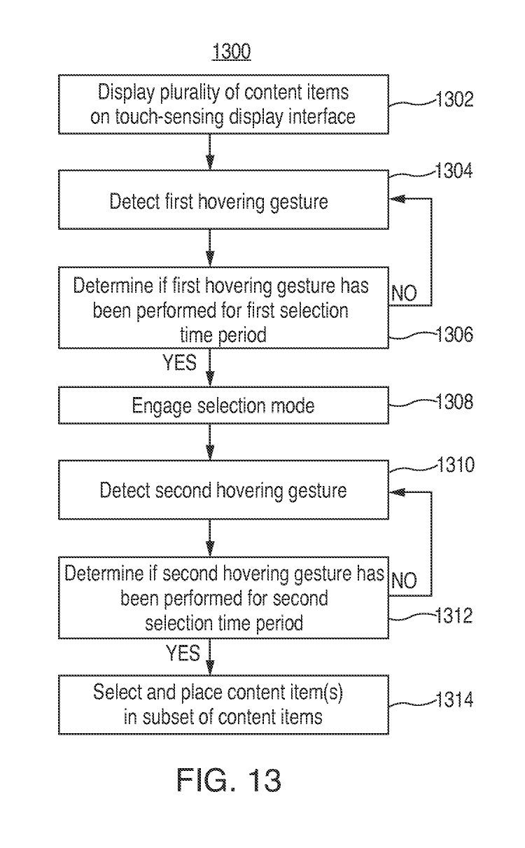

FIG. 13 is an illustrative flowchart of a process that uses hovering gestures to select content items in accordance with various embodiments. Process 1300 may begin at step 1302. At step 1302, a plurality of contents may be displayed on a touch-sensing display interface. For example, content items 206 may be displayed on touch-sensing display interface 204 of FIG. 2A. Content items may include photographs, music files (e.g., mp3s), videos, text documents, presentations, or any other file type, or any combination thereof. The touch-sensing display interface may be any display screen capable of displaying content and receiving gestures. In some embodiments, step 1302 may be substantially similar to step 902 of FIG. 9, and the previous description of the latter may apply to the former.

At step 1304, a first hovering gesture may be detected by a touch-sensing display interface, which may include one or more software modules configured to detect and interpret gestures from various physical inputs. In some embodiments, the first hovering gesture may include an object being placed a distance above a touch-sensing display interface. For example, finger 802 of FIG. 8 may be placed distance D above touch-sensing display interface 804. The touch-sensing display interface may detect that the object (e.g., finger 802) hovering above it. In some embodiments, distance D may be pre-determined by one or more modules on a device associated with the touch-sensing display interface subject to any hardware limitations. For example, the pre-determined distance may range between 0.1 mm-10 mm, which may be defined beforehand by one or more software modules during device configuration. In some embodiments, one or more fingers, a stylus, a computer compatible pen, or any other object may be detected hovering above the touch-sensing display interface.

At step 1306, a determination may be made by the touch-sensing display interface as to whether the first hovering gesture has been performed for a first selection time period. For example, one or more modules on device 808 may determine that finger 802 has hovered a distance D above touch-sensing display interface 804 for a period of time. The period of time that the object hovers above the touch-sensing display interface may be compared to a predefined selection time period. For example, the period of time that finger 802 hovers over touch-sensing display interface 804 may be compared to selection time period 262 of FIG. 2.

As noted above, in some embodiments, the device may detect deviations in the distance between the touch-sensing display interface and the object that may be hovering above it. For example, device 808 may include a variance indicator that may detect if distance D changes by more or less than a predefined deviation, Δ. Thus, while finger 802 may generally hover the distance D over touch-sensing display interface 804, finger 802 may change to hover between distances D+Δ and D−Δ, and device 808 may detect the change. If finger 802 changes to hover a distance greater than D±Δ, then device 808 may detect that the change has exceeded the deviation and an appropriate action may occur.

At step 1306, a determination may be made as to whether the first hovering gesture has been performed for a first selection time period. In some embodiments, the period of time the object hovers above the touch-sensing display interface may be compared to the first selection time period to determine whether or not the period of time is greater than or equal to the predefined selection time period. Continuing with the previous example, finger 802 may hover above touch-sensing display for a period of time which may be compared to the predefined selection time period 262.

If, at step 1306, it is determined that the first hovering gesture has not been performed for the first selection time period, process 1300 may return to step 1304 to continue to monitor hovering gestures. However, if at step 1306 it is determined that the first hovering gesture has been performed for a period of time equal to or greater than the selection time period then process 1300 may proceed to step 1308 where a selection mode may be engaged. In some embodiments, the selection mode may allow a user to select and place one or more content items from the displayed content items in a subset of content items.

At step 1310, a second hovering gesture being performed on the touch-sensing display interface about one or more content items may be detected. In some embodiments, the object may hover a distance above a content item displayed on the touch-sensing display interface. For example, finger 802 may hover a distance D above touch-sensing display interface 804 and a content item may be displayed on the touch-sensing display interface underneath finger 802.

At step 1312, a determination may be made as to whether the second hovering gesture has been performed for a second selection time period. For example, once the selection mode has been engaged, finger 802 may hover over a content item displayed on touch-sensing display interface 804. Finger 802 may hover above the content item for a second period of time. The second period of time may be compared to the second selection period of time to determine whether or not the second period of time is equal to or greater than the second selection time period. In some embodiments, the second selection time period may be substantially similar to the first selection time period with the exception that the second selection time period may be operable to select a content item. In some embodiments, the second selection time period may be substantially less time than the first selection time period. For example, if the first selection time period is 3 seconds, the second selection time period may be 1 second. The second selection time period may be any amount of time capable of selecting one or more content items. In some embodiments, the second selection time period may be predetermined by a user defined setting, a content management system (e.g., content management system 100), or any other mechanism capable of defining the second selection time period.

If at step 1312 it is determined that the second hovering gesture has not been performed for the second selection time period, then process 1300 may return to step 1310. For example, if the second selection time period is 1 seconds and at step 1312 it is determined that finger 802 has hovered above touch-sensing display interface 804 for ½ second, then no action may be taken and monitoring may continue to occur to detect gestures. In some embodiments, the touch-sensing display interface may be capable of determining whether the object has hovered above a single content item for less than the second selection time period. For example, finger 802 may hover over a first content item for ½ second but may then move to hover over a second content item for 1 second. If the second selection time period is 1 second, the first content item hovered over may not be selected, and the second content item may not be selected until it has been determined that finger 802 has hovered over it for the full 1 second. This may help to prevent erroneous selection of content items while a user may hover over the touch-sensing display interface.

If at step 1312 it is determined that the second hovering gesture has been performed for the second selection time period (or greater than the second selection time period), then process 1300 may proceed to step 1314. At step 1314 a selection of one or more content items may occur. For example, finger 802 may hover over a content item display on touch-sensing display interface 804 for 3 seconds. If the second selection time period equals 3 seconds, then the content item may be selected and placed in the subset of content items.

In some embodiments, the second hovering gesture may be performed more than one time to select multiple content items to be placed in the subset. For example, finger 802 may hover above one content item displayed on touch-sensing display interface 804 for the second selection time period to place the one content item in the subset of content items. Finger 802 may then also move laterally about touch-sensing display interface 804 such that finger 802 may hover over a second content item display on the touch-sensing display interface 804. Finger 802 may then hover above the second content item for the second selection period of time to select and place the second content item in the subset along with the one content item previously selected.

In some embodiments, one or more additional hovering gestures may be performed after the subset's creation. For example, the user may swipe a distance above the touch-sensing display interface, pinch the periphery of the touch-sensing display interface, wave a hand, or perform any other gesture, or any combination thereof. In some embodiments, the additional hovering gesture may correspond to an action that may be performed on the subset of content items. For example, a user may wave a hand above the touch-sensing display interface and the subset may automatically be shared with a content management system.

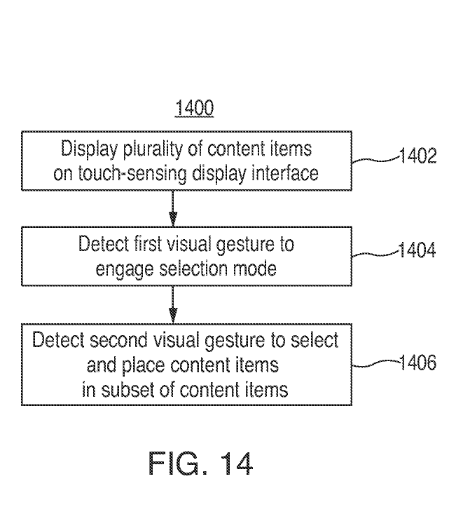

FIG. 14 is an illustrative flowchart of a process that uses visual gestures to select content items in accordance with various embodiments. Process 1400 may begin at step 1402 where a plurality of content items may be displayed on a touch-sensing display interface. For example, content items 206 may be displayed on touch-sensing display interface 204 of FIG. 2A. Content items may include photographs, music files (e.g., mp3s), videos, text documents, presentations, or any other file type, or any combination thereof. The touch-sensing display interface may be any display screen capable of displaying content and receiving gestures. In some embodiments, step 1402 may be substantially similar to step 902, and the previous description of the latter may apply to the former.

Process 1400 may continue at step 1404. At step 1404, a first visual gesture may be performed to engage a selection mode. In some embodiments, the first visual gesture may be performed in connection with an eye-tracking system. For example, a device (e.g., client device 102 of FIG. 1) may include one or more retinal or visual monitoring modules. In some embodiments, the device may have stored in memory a retinal scan of an authorized user of the device and the device may track eye movements of the authorized user. In some embodiments, the user may stare at a portion of the user device and the one or more visual tracking modules may determine that the retinal image matches a stored image corresponding to an authorized user. In some embodiments, determining that the retinal image matches the stored image may allow the device to engage in a selection mode automatically. In some embodiments, the visual tracking modules may track the movement of a user's eyes, and based on the tracked motion, engage in the selection mode.

In some embodiments, the first visual gesture may be a motion made by the user of the device. For example, a user of a device (e.g., device 102) may make a clapping motion, a swinging motion, raise a hand/arm, or any other motion that may be tracked by visual monitoring modules. In some embodiments, specific motions may engage a selection mode. For example, a user may hold a hand up in the air for a period of time and the device may track the hand to determine that the hand has been raised in the air. Continuing with this example, the device may also determine that the hand has been held in a position for a specific amount of time (e.g., selection time period 262) which may engage in a selection mode.

Process 1400 may then proceed to step 1406. At step 1406, a second visual gesture may be performed to select and place one or more content items in a subset of content items. In some embodiments, the second visual gesture may include detecting when a visual gesture has occurred to select the content items. For example, the user may stare at a content item for an amount of time and a visual tracking module may detect the stare as well as detect that the user is staring at the content item. The tracking module may then select the content item and place the content item in the subset. In some embodiments, the tracking modules may detect a user visually scanning over one or more content items. For example, a user may visually sweep across one or more displayed content items and the tracking modules may select those content items and place them in the subset.

In some embodiments, the visual tracking modules may detect a motion made by the user to select one or more content items. For example, the user may point at a content item, pinch the air about a content item, draw a circle in the air, or perform any other motion, or any combination thereof. The performed visual motion may select one or more content items and place the content item(s) in the subset.

### Exemplary Systems

In exemplary embodiments of the present invention, any suitable programming language may be used to implement the routines of particular embodiments including C, C++, Java, JavaScript, Python, Ruby, CoffeeScript, assembly language, etc. Different programming techniques may be employed such as procedural or object oriented. The routines may execute on a single processing device or multiple processors. Although the steps, operations, or computations may be presented in a specific order, this order may be changed in different particular embodiments. In some particular embodiments, multiple steps shown as sequential in this specification may be performed at the same time

Particular embodiments may be implemented in a computer-readable storage device or non-transitory computer readable medium for use by or in connection with the instruction execution system, apparatus, system, or device. Particular embodiments may be implemented in the form of control logic in software or hardware or a combination of both. The control logic, when executed by one or more processors, may be operable to perform that which is described in particular embodiments.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments may be achieved by any means as is known in the art. Distributed, networked systems, components, and/or circuits may be used. Communication, or transfer, of data may be wired, wireless, or by any other means.

It will also be appreciated that one or more of the elements depicted in the drawings/figures may also be implemented in a more separated or integrated manner, or even removed or rendered as inoperable in certain cases, as is useful in accordance with a particular application. It is also within the spirit and scope to implement a program or code that may be stored in a machine-readable medium, such as a storage device, to permit a computer to perform any of the methods described above.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

While there have been described methods using gestures to select content items, it is to be understood that many changes may be made therein without departing from the spirit and scope of the invention. Insubstantial changes from the claimed subject matter as viewed by a person with ordinary skill in the art, no known or later devised, are expressly contemplated as being equivalently within the scope of the claims. Therefore, obvious substitutions now or later known to one with ordinary skill in the art are defined to be within the scope of the defined elements. The described embodiments of the invention are presented for the purpose of illustration and not of limitation.

### APPENDIX

### Exemplary Gesture Tables

The following presents exemplary gestures that may be used for each of (1) engaging a selection mode, and once in such a mode (2) selecting content items for various purposes. These examples are for illustrative purposes, and understood to be non-limiting. They are presented as a convenient collection of the various gestures discussed above in one place. It is understood that various combinations of the two columns are possible, as well as additional gestures in each category.

| Gestures Operable to Engage a | Gestures Operable to Select |
|---|---|
| Selection Mode | Content Items |
| Long press | Swiping using an object |
| Contact with two or more fingers | Swiping using a finger |
| Detect authorized fingerprint | Swiping using multiple fingers |
| Hover for a predefined period of | Tapping |
| time | |
| Retinal Scan | Hovering for a predefined period |
| | of time |
| Hand wave | Motioning about content items |
| Vocal command | Retinal tracking |
| | Vocal commands (e.g., “Select |
| | All,” “Select first row”) |

What is claimed is:

1. A method comprising:
displaying a plurality of content items on a touch-sensing display interface of a user device;
detecting a first tactile gesture on the touch-sensing display interface, the first tactile gesture engaging a selection mode;
detecting a second tactile gesture on the touch-sensing display interface, the second tactile gesture selecting and placing at least one of the plurality of content items in a subset.

2. The method of claim 1, further comprising:
performing at least one action on the subset of content items in response to an additional user input being detected by the touch-sensing display interface.

3. The method of claim 2, wherein the additional user input comprises at least one of:
at least one additional gesture;
tactile selection of pop up active buttons; and
voiced commands.

4. The method of claim 1, wherein:
the plurality of content items comprise a plurality of photographs stored in a photo gallery.

5. The method of claim 4, wherein the photo gallery is located on at least one of:
the user device;
an authorized account on a social media networks; and
an authorized account on a content management system.

6. The method of claim 1, wherein detecting the first tactile gesture on the touch-sensing display interface comprises detecting at least one object being placed in contact with the touch-sensing display interface.

7. The method of claim 6, wherein the at least one object comprises at least one of:
at least one finger;
a stylus; and
a computer compatible pen.

8. The method of claim 1, wherein detecting the first tactile gesture on the touch-sensing display interface comprises at least one of:
detecting at least one object being placed in contact with the touch-sensing display interface for a first period of time engaging the selection mode;
detecting at least one object being placed in contact with the touch-sensing display interface; and
detecting at least two fingers being placed in contact with the touch-sensing display interface.

9. The method of claim 8, wherein placing the at least two fingers in contact with the touch-sensing display interface automatically engages the selection mode.

10. The method of claim 8, wherein detecting the second tactile gesture on the touch-sensing display interface comprises detecting a swiping motion performed by the at least one object on the touch-sensing display interface.

11. The method of claim 10, wherein:
the swiping motion swipes the at least one object about the plurality of content items displayed on the touch-sensing display interface; and
swiping about the at least one content item selects and places the at least one content item in the subset of content items.

12. The method of claim 1, wherein the action comprises sharing the subset of content items with at least one of:
a contact;
a content management system; and
a social media network.

13. The method of claim 1, further comprising:
providing a pop-up notification on the touch-sensing display interface with at least one option, the at least one option comprising at least the first action.

14. The method of claim 1, wherein the displayed plurality of content items are displayed on a first screen of the touch-sensing display interface, the method further comprises:
detecting that the second tactile gesture is no longer in contact with the touch-sensing display interface; and
displaying the subset of content items on a second screen of the touch-sensing display interface.

15. The method of claim 1, further comprising:
detecting a third tactile gesture on the touch-sensing display interface, the third tactile gesture being operable to edit the subset of content items.

16. The method of claim 1, wherein the second tactile gesture comprises lassoing the at least one content item, the lassoing selecting and placing the at least one content item in the subset of content items.

17. The method of claim 1, further comprising:
monitoring, after detecting the first tactile gesture, the touch-sensing display interface for the second tactile gesture.

18. A method comprising:
displaying a plurality of content items on a touch-sensing display interface of a user device;
detecting a first tactile gesture on the touch-sensing display interface, the first tactile gesture engaging a selection mode;
detecting a second tactile gesture on the touch-sensing display interface, the second touch selecting and placing at least one content item in a subset of content items; and
detecting a third tactile gesture on the touch-sensing display interface, the third touch gesture automatically sharing the subset of content items.

19. The method of claim 18, wherein the plurality of content items comprises a plurality of photographs stored in a photo gallery, the photo gallery being located on at least one of:
the user device;
an authorized account on a social media network; and
an authorized account on a content management system.

20. The method of claim 18, wherein detecting the first tactile gesture with the touch-sensing display interface comprises detecting at least one object being placed in contact with the touch-sensing display interface.

21. The method of claim 20, wherein:
detecting the second tactile gesture with the touch-sensing display interface comprises detecting a swiping motion being performed by the at least one object about the touch-sensing display interface selecting and placing the at least one content item in the subset of content items.

22. The method of claim 20, wherein detecting the third tactile gesture with the touch-sensing display interface comprises at least one of:
detecting a swiping motion being performed by the at least one object across the touch-sensing display interface; and
detecting a flicking motion being performed by the at least one object.

23. The method of claim 18, wherein detecting the first tactile gesture with the touch-sensing display interface comprises detecting a long press on the touch-sensing display interface.

24. A method comprising:
detecting at least two fingers contacting the touch-sensing display interface,
determining that the at least two fingers correspond to an authorized account of the user device;
engaging in a selection mode in response to determining that the at least two fingers correspond to the authorized account; and
detecting a tactile gesture on the touch-sensing display interface selecting and placing at least one content item from a plurality of content items in a subset of content items.

25. The method of claim 24, further comprising:
detecting a swiping motion with the at least two fingers on the touch-sensing display interface; and
automatically sharing the subset of content items in response to detecting the swiping motion with the at least two fingers.

26. The method of claim 25, wherein the subset is automatically shared with at least one contact associated with the authorized account.

27. The method of claim 26, wherein the authorized account comprises an authorized account on a content management system.
